(19) United States
(12) Patent Application Publication
(10) Pub. No.: US 2016/0121467 A1
(43) Pub. Date: May 5, 2016

(54) Impact Driver Control System

(71) Applicant: BLACK & DECKER INC., Newark, DE (US)

(72) Inventors: Wong Kun Ng, New York, NY (US); Oleksiy P. Sergyeyenko, Baldwin, MD (US); Kevin Wenger, Bel Air, MD (US)

(73) Assignee: BLACK & DECKER INC., Newark, DE (US)

(21) Appl. No.: 14/596,922

(22) Filed: Jan. 14, 2015

Related U.S. Application Data
(60) Provisional application No. 62/073,931, filed on Oct. 31, 2014.

(51) Int. Cl. B25B 21/02; B25F 5/00

(52) U.S. Cl. CPC B25B 21/02; B25F 5/00

(57) ABSTRACT

An impact driver having an impact driver control system which can activate a driver release. The activation of a driver release can be controlled by an electronic controller which can be set to activate a driver release when parameters of the impact drivers meet specified conditions.

### CROSS-REFERENCE TO RELATED APPLICATIONS

This patent application is a non-provisional application of and claims the benefit of the filing date of copending U.S. provisional patent application No. 62/073,931 entitled “Impact Driver Control System” filed on Oct. 31, 2014.

### FIELD OF THE INVENTION

This invention in its several and varied embodiments regards fastening tools.

### INCORPORATION BY REFERENCE

This patent application incorporates by reference in its entirety copending U.S. provisional patent application No. 62/073,931 entitled “Impact Driver Control System” filed on Oct. 31, 2014, and having confirmation number 7542.

### BACKGROUND OF THE INVENTION

Impact drivers suffer from problems associated with inadequate drive mechanism performance and control. Impact drivers having such inadequate driver control can improperly drive a fastener, drive a fastener too deeply into a workpiece, or fail to drive a fastener to a desired depth. Additionally, improper driver control can cause a stripping of the head of a fastener, or damage to the fasteners threads or to the workpiece itself. A lack of motor control, unpredictable or inconsistent impacting, inconsistent power during a driving of a fastener. Insufficient design of impact driver control results in loss of time, destruction of materials, re-work and user frustration or inability to achieve a quality fastener installation.

In addition to the above, when an impact driver uses a hammer to turn and/or impact an anvil, poor driver control of the hammer results in unacceptable wear of both the hammer and impacted anvil, as well as wear to the drive system and its components. Overheating, mechanical failure and shortened tool life can result from poor driver control of an impact driver.

Poor driver control can also cause unsatisfactory power management. A lack of effective power management can result in shortened usage periods, power loss, revving of the motor, power spikes and unpredictability in drive performance. For cordless power tools failures in power management, shortened battery life, poor and inconsistent power output, and inadequately controlled drive systems can reduce the effectiveness of the tool and its usefulness to an operator. There is a strong need for improved driver control and power management for impact drivers.

### SUMMARY OF THE INVENTION

Applicant's invention in its several and varied embodiments significantly improves the technology of impact drivers. The disclosed driver control technology improves performance and quality in driving fasteners. The impact driver control system reduces mechanical damage and wear on drive mechanism and tool components. The impact driver control system increases tool life and battery usage, as well as improving repeatability of drive characteristics. Additionally, the disclosed driver control technology achieves improvements in power management, motor control, battery usage and increases the number of drives per charge which can be obtained from a cordless impact driver.

An impact driver can have a motor which can provide a driving force to an impact mechanism. The impact driver can have a controller which can be an electronic controller and which can control the state of a driver control system. The controller can monitor a parameter of the impact driver and can be configured to activate the driver control system to free the impact mechanism from the driving force when the parameter satisfies a driver release condition. In an embodiment the release activation value of the parameter which satisfies the driver release condition can vary depending upon one or more driving conditions.

An impact driver can have a motor which can provide a driving force to an impact mechanism. An output spindle can transmit the driving force of the motor to the impact mechanism. The impact driver can have a controller which can be an electronic controller and can control the state of a driver control system. The controller can monitor a parameter of the impact driver and can be configured to activate the driver control system to free the output spindle from the driving force when the parameter satisfies a driver release condition. In an embodiment, a release activation value of the parameter which satisfies the driver release condition can vary depending upon one or more, or at least one, of a driving condition. Thus, the driver release condition can be satisfied and/or a driver release can occur at different values under one or more different driving conditions. For non-limiting example, the parameter can be at least one of: a current, such as a motor current; an rpm of a motor; and a torque, such as a motor torque.

In an embodiment, the parameter can be the motor current and can satisfy a driver release condition when the motor current exhibits a first decrease of the motor current over a first time period, followed by a first increase in motor current over a second time period, followed by a second decrease of the motor current over a third time period, followed by a second increase in in motor current over a fourth time period.

In another embodiment, the parameter can be the motor current which can satisfy a driver release condition when the motor current exhibits an increase over each of a number of sequential sampling periods.

In an embodiment, the parameter can be the motor current which can satisfy a driver release condition when the motor current exhibits an increase in the motor current to a value greater than an upper limit of motor current.

In an embodiment, the parameter can be the motor current which can satisfy a driver release condition when the motor current exhibits a decrease in the motor current over each of a number of sequential sampling periods.

In an embodiment, the parameter can be the motor current which can satisfy a driver release condition when the motor current exhibits a decrease in the motor current to a value lower than a lower limit of motor current. In another embodiment, the parameter can be the motor current which can satisfy a driver release condition when the motor current exhibits a change in the motor current, wherein the change in current is less than a current change limit over a number of sampling periods. In yet another embodiment, the parameter can be the motor current which can satisfy a driver release condition when the motor current exhibits a change in the motor current, wherein the motor current remains within an upper limit of motor current and a lower limit of motor current over a period of time greater than a driver release activation time.

In an embodiment, the parameter can be the motor current which can satisfy a driver release condition when the motor current exhibits a first decrease of the motor current over a first time period, followed by a first increase in motor current over a second time period, followed by a second decrease of the motor current over a third time period followed by a second increase in in motor current over a fourth time period, followed by an increase in a motor current over each of a number of sequential sampling periods.

A driver release can be affected by a driving condition. A driving condition is that which affects the driving of a fastener by an impact driver. In non-limiting example, a driving condition can be one or more factors or properties of driving a fastener into a workpiece, such as one or more of the following items or types of such items: wood, pine board, pine lumber, plywood, drywall, metal, concrete, ceramic, glass, plastic, composite, laminate and other materials into which impact drivers drive fasteners. In embodiments, the fastener being driven and/or the workpiece into which a fastener is driven can themselves constitute one or more driving conditions. The physical properties of a fastener and/or workpiece, as well as the operating environment regarding a driving action can also be driving conditions which affect driver release.

An rpm value of a motor and/or a spindle (e.g. the output spindle) and/or bit holder assembly and/or bit holder can be used as the parameter for driver release. A motor's speed (e.g. measured by rotations per minute (“rpm”)) and/or spindle speed and/or bit holder assembly and/or bit holder measured in rpm and/or hammer speed measured in rpm can be used as the parameter for determining a driver release condition and/or to activate a driver release. Driver motor speeds and/or spindle speeds and/or hammer speeds which can cause driver release can be for non-limiting example be in a range of 1,500 rpm to 50,000 rpm, or 2,200 rpm to 45,000, or 3,500 rpm to 45,000, or 5,000 rpm to 45,000, or 7,500 rpm to 22,000, or 10,000 rpm to 18,000, or 12,000 rpm to 25,000, or 15,000 rpm to 25,000, or 18,000 rpm to 30,000, or 20,000 rpm to 35,000, or 23,000 rpm to 40,000, or 25,000 rpm to 40,000, or 30,000 rpm to 40,000, or 33,000 rpm to 45,000, or 35,000 rpm to 50,000. The set point of the rpm parameter can also be a speed designated by the manufacturer or operator of for example 3,300 rpm, 3,500 rpm, 7,500 rpm, 12,000 rpm, 15,000 rpm, 17,500 rpm, 20,000 rpm, 22,000 rpm, 25,000 rpm, 30,000 rpm, 40,000 rpm, 50,000 rpm, or greater.

In an embodiment, a torque can be used as the parameter for determining driver release. For non-limiting example, one or more of the following types of torque can be used as the parameter for determining a driver release condition and/or to activate a driver release: motor torque, torque on output spindle, torque on hammer, torque on anvil, torque on bit holder assembly, torque on bit, torque on fastener, or torque on workpiece.

In an embodiment, the parameter can be the motor torque and can satisfy the driver release condition. For example, the driver release condition can be satisfied when the motor torque has a value in a range of 10 in/lbs to 10000 in/lbs, or 150 in/lbs to 1500 in/lbs, or 1250 in/lbs to 10000 in/lbs, or 3000 in/lbs to 7000 in/lbs, or 5000 in/lbs to 10000 in/lbs, or 150 in/lbs to 6000 in/lbs. The motor torque can also have a predetermined torque value as a set point to activate driver release, such as 10 in/lbs, 100 in/lbs, 1000 in/lbs, 3000 in/lbs, 5000 in/lbs, 10000 in/lbs, or any value in between.

In an embodiment, when the controller identifies the driver release condition, the driver control system can activate a driver release which frees a spindle, such as the output spindle, from receiving a torque. The release condition can be a first driving torque for a first fastener in a first workpiece, and the drive release condition can be a second driving torque for a second fastener in a second workpiece. When the first driving torque and second driving torque are different the driver release condition can be satisfied and a driver release can be activated. In an embodiment, the first driving torque can be at least 3%, 5%, 10%, 20%, or 30% different than the second driving torque. In another embodiment, the first driving torque can be at least 3%, 5%, 10%, 20%, or 30 higher than the second driving torque. In yet another embodiment, the first driving torque can be at least 3%, 5%, 10%, 20%, or 30 lower than the second driving torque.

A release activation value can be any value of any parameter which causes or is a basis for a driver release. One or more release activation values can be used to satisfy one or more driver release conditions which can cause a driver release. In an embodiment, the impact driver can have a release activation value which varies depending upon a type of fastener being driven. For example, the release activation value used can be affected by one or both of the type of fastener being driven and the type of workpiece into which the fastener is being driven.

In an embodiment, an impact driver can have an output spindle transmitting the driving force of the motor to the impact mechanism and a controller configured to activate the driver control system to free the output spindle from the driving force when the parameter satisfies a driver release condition.

An impact driver control system can have a motor which can provide a driving force to an impact mechanism and an electronic controller which can control the state of a driver control system. The controller can monitor a parameter of the impact driver to identify a driver release condition. When the controller identifies the driver release condition, the driver control system can activate a driver release which can free the impact mechanism from receiving the driving force. In an embodiment, the driver release condition can be satisfied by a first motor torque while driving a first fastener, and by a second motor torque while driving a second fastener. The first motor torque can be different from the second motor torque.

In an embodiment, an impact driver control system can have an output spindle which can provide a driving force to an impact mechanism and can also have an electronic controller which controls the state of a driver control system. The controller can monitor a parameter of the impact driver to identify a driver release condition. When the controller identifies the driver release condition, the driver control system can activate a driver release which frees a spindle from receiving a driving force. In an embodiment, the driver release condition can be satisfied by a first motor torque while driving a first fastener and the driver release condition is satisfied by a second motor torque while driving a second fastener. The motor torque values which can satisfy the driver release condition can be the same or different. In an embodiment, the first motor torque can be at least 3% different than the second motor torque. In other embodiments, the first motor torque can be different than the second motor torque by at least 10%, or 20%.

The driver release condition can be satisfied by a percentage of difference in motor torque set by the manufacturer or operator. For example, a driver release condition can have a set point from 0% difference in the motor torque to 1,000%, or to 10,000% difference in motor torque. The percent difference in motor torque which can activate a driver release can be selected from a low torque value to a high torque value. In non-limiting example, percent differences between a first and a second motor torque can be 1%, 3%, 5%, 10%, 15%, 20%, 25%, 50%, 100%, 500%, 1,000%, or higher, or any number in between. The driver release condition can also be satisfied when the difference between a first and a second motor torque is within a range, such as in non-limiting example 1% to 1,000%, or 2% to 10%, or 3% to 20%, or 10% to 50%, or 10% to 500%. In an embodiment, the percent difference between a first and a second motor torque used to activate a driver release can be a positive difference between torque values, or a negative difference between torque values. In an embodiment, an absolute value of a difference between a first motor torque and a second motor torque can be used. The first motor torque can be different, higher or lower, than the second motor torque by at least 1%, 3%, 5%, 10%, 15%, 20%, 30%, 50%, 100%, 1,000%, or any value in between.

In an embodiment, the controller can monitor a parameter of time to identify, or which will satisfy, a driver release condition. For example, the driver release condition can be satisfied by a first driving time for the first fastener and by a second driving time for the second fastener. In an embodiment, the first driving time can be at least 20% different than the second driving time. In an embodiment, the driver release condition can be set for example such that the first driving time can be at least 20% longer than the second driving time, or at least 20% shorter than the second driving time.

In an embodiment, an impact driver control system can have an electronic controller which controls the state of a driver control system. The controller can monitor a parameter of the impact driver to identify a driver release condition. When the controller identifies a driver release condition, the driver control system can activate a driver release which frees a spindle from receiving a torque. In an embodiment, the driver release condition can be identified at a first driving time for a first fastener in a first workpiece and the driver release condition is identified at a second driving time for a second fastener in a second workpiece. In an embodiment, the first driving time can be at least 10%, 20%, 30%, 40% or 50% different from the second driving time. In another embodiment, the first driving time can be at least 10%, 20%, 30%, 40%, or 50% longer than the second driving time. In yet another embodiment, the first driving time can be at least 10%, 20%, 30%, 40%, or 50% shorter than the second driving time.

The driver release condition can be satisfied by a percentage of difference in driving time which can be set by the manufacturer or operator. For example, a driver release condition can have a set point of from 0% difference in driving time to a 500% difference in driving time. In non-limiting example, percent differences between a first and a second driving time can be 1%, 3%, 5%, 10%, 15%, 20%, 25%, 50%, 100%, 500% or higher, or any number in between. The set point can also be set to satisfy a driver release condition if the percent difference between a first and a second driving time is within a range such as in non-limiting example 1% to 50%, or 5% to 200%, or 100% to 500%.

In an embodiment, the driver release condition can be activated at a designated time, or set point of time. For example, based upon a type of fastener, or workpiece, or other factor, or combination of factors, a manufacturer or operator can designate the amount of driving time which activates a driver release condition. For non-limiting example, the driver release condition can be activated at a time of less than one second to 10 minutes, such as 5 ms, 10 ms, 15 ms, 20 ms, 25 ms, 30 ms, 40 ms, 50 ms, 75 ms, 100 ms, 125 ms, 150 ms, 200 ms, 0.5 s, 1 s, 2 s, 3 s, 4 s, 10 s, 30 s, 60 s, or 5 min, or any value in between. The set point for time to activate the driver release condition can also be at a time within a range, such as 5 ms to 500 ms, or 5 ms to 300 ms, or 5 ms to 200 ms, or 5 ms to 200 ms, or 5 ms to 100 ms, or 10 ms to 150 ms, or 25 ms to 75 ms, or 50 ms to 200 ms, or 1 ms to 2 s, or 1 ms to 10 s, or 0.5 s to 3 s, or 3 s to 8 s, or 10 s to 20 s, or 1.5 s to 15 s.

In an embodiment, the impact driver can have an output spindle which can transmit the driving force of the motor to the impact mechanism and can have a mechanical release which can free the output spindle from the driving force when the parameter satisfies a driver release condition.

An impact driver can have a motor which provides a motor force that drives an output spindle. The output spindle can provide a driving force to an impact mechanism. The impact driver can have a controller which can be an electronic controller and which can controls the state of a driver control system and which can monitor a parameter of the impact driver. The controller can be configured to activate the driver control system to free the spindle from the driving force when the parameter satisfies a driver release condition. In an embodiment, the driver release condition can be a fastener driven by the impact driver into a workpiece to a point where the fastener is approximately flush with the workpiece.

In an embodiment, the impact driver can have a spindle which can be driven by a driving force and a controller which can be an electronic controller and which can control the state of a driver control system. The controller can monitor a parameter of the impact driver and the controller can be configured to activate the driver control system to free the spindle from the driving force when the parameter satisfies a driver release condition. In an embodiment, the driver release condition is indicative and/or correlated to a fastener being driven by the impact driver into a workpiece to a point where it is approximately flush with the workpiece. In another embodiment, the timing of the driver release condition varies such that a variety of fasteners can be driven into a variety of workpieces to an approximately flush condition.

In an embodiment, the impact driver can drive a fastener into a workpiece in a range of flushness, such as from flush to not flush, or to proud. Flushness herein regards the percentage of a fastener and/or fastener head portion which is not embedded in a workpiece or which is not even with a surface of a workpiece. A positive flushness means the fastener has a portion which extends from the surface of the workpiece and a negative flushness means the fastener head portion is embedded into the work piece such that no part extends from the surface or is even with the surface of the workpiece. Herein, “embedded” is used synonymously with “sunk” and “overdriven”, as referring to a negative flushness. A fastener is flush with a workpiece surface when a portion of the driver fastener is generally coplanar with a surface of a workpiece.

In an embodiment, a fastener can be driven so that the driver release condition is met when a portion of a fastener and/or a fastener's head portion is flush with and/or generally coplanar with the surface of the workpiece, e.g. “flush”, “generally flush” or “approximately flush” which are terms used synonymously herein. Herein, the terms “flush”, “generally flush” and “approximately flush” include within their respective scopes a tolerance or intended % of length which will not be flush. Herein, how flush a fastener is upon completion of driving can be calculated as a percentage of nail length, or fastener head portion length, “% of flush”, based upon the respective length which is not embedded into the workpiece or which is sunk into a workpiece, e.g. 1% of flush, 5% of flush, 10% of flush, 25% of flush, or other value. The state, or measure, of how flush a driven fastener is can also be recited within a range of 0% of flush to 50% of flush, or 0.5% of flush to 10% of flush. The driver release condition can be set to result in a driver release to achieving a percent of flush of a fastener of any value of flushness whether a positive flushness (or proud) or a negative flushness (or sunk or embedded).

In an embodiment, the impact driver can have a driver release condition which varies such that a plurality of different fasteners can be driven into a workpiece or a plurality of different workpieces to an approximately flush condition. In an embodiment, the impact driver can have a driver release condition which varies such that a number of similar fasteners can be driven into a workpiece or a plurality of different workpieces to an approximately flush condition.

In an embodiment, the driver release condition can vary such that a plurality of similar, or different, fasteners can be driven into one or more similar, or different, workpieces to an approximately flush condition. In an embodiment, the impact driver can have a driver release condition which varies such that a variety of different fasteners can be driven into a number of similar or different workpieces to an approximately flush condition.

The impact driver can have the driver release condition of time set to one or more values of time such that a variety of similar or different fasteners can be driven into a number and/or variety of similar or different workpieces to an approximately flush condition.

In an embodiment, the impact driver can drive a fastener into a workpiece in a range of proudness from 0% proud (perfectly flush to workpiece) to very proud (e.g. 90% proud), where “proud” refers to a condition in which a driven fastener has a “proud” portion which extends from and/or is not embedded into the workpiece. Herein, the measure of how proud a fastener is upon driver release, or completion of a drive, is referred to as a percentage of a length of the fastener which is not embedded into the workpiece, e.g. “% proud”, such as 1% proud, 5% proud, 10% proud, 25% proud, or more. How proud a driven fastener is can also be recited within a range of 0% proud to 50% proud, or 0.5% proud to 10% proud. The driver release condition can be set to result in a driver release to achiever a percent of proud of a fastener of any value.

An impact driver, having an output spindle which is driven by a driving force and a controller which can be an electronic controller and which controls the state of a driver control system. The controller can monitor a parameter of the impact driver. The controller can be configured to activate the driver control system to free the output spindle from the driving force when the parameter satisfies a driver release condition. In an embodiment, the value of the parameter at which the driver release condition is satisfied varies depending upon a type fastener being driven and a type of workpiece into which the fastener is being driven. The parameter which is monitored by the controller can be one or more of the following: a current, a motor current, an rpm of a motor, and a torque.

In an embodiment, the parameter can be a motor current and the driver release condition can have a first decrease of the motor current over a first time period followed by a first increase in motor current over a second time period; followed by a second decrease of the motor current over a third time period followed by a second increase in motor current over a fourth time period. In another embodiment, the parameter can be a motor current and the driver release condition can have an increase in a motor current over each of a number of sequential sampling periods. In yet another embodiment, the parameter can be a motor current and the driver release condition can have an increase in the motor current to a value greater than an upper limit of current. Herein, disclosure that the driver release condition “can have”, is “having”, or “has”, any criteria means in addition to the ordinary and customary meaning of these terms that such criteria are used synonymously to mean that any recited criteria satisfy, or are set points for, or identify, or meet, or identify, the conditions for driver release. These expressions are intended to be synonymous with a driver release condition “comprising” any recited criteria, or driver release condition.

In an embodiment, the parameter can be a motor current and the driver release condition can have a decrease in a motor current over each of a number of sequential sampling periods. In another embodiment, the parameter can be a motor current and the driver release condition can have a decrease in a motor current to a value lower than a lower limit of current. In yet another embodiment, the parameter can be a motor current and the driver release condition can have a change in the motor current, wherein the change in current is less than a current change limit over a number of sampling periods.

In another embodiment, the parameter can be a motor current and the driver release condition can be satisfied by a change in the motor current, wherein the current remains within an upper limit of current and a lower limit of current over a period of time greater than a driver release activation time.

In another embodiment, the parameter can be a motor current and the driver release condition can have a first decrease of the motor current over a first time period followed by a first increase in motor current over a second time period; followed by a second decrease of the motor current over a third time period followed by a second increase in motor current over a fourth time period, followed by an increase in a motor current over each of a number of sequential sampling periods.

In an embodiment, the impact driver control system can have an electronic controller which controls the state of a driver control system; a controller which monitors a motor current in which the controller monitors the current to identify a driver release condition. The driver release condition can have a first decrease of motor current over a first time period followed by a first increase in motor current over a second time period, which is followed by a second decrease of motor current over a third time period followed by a second increase in motor current over a fourth time period; when the controller identifies the driver release condition, the driver control system frees an output spindle from receiving a torque.

In an embodiment, the impact driver control system can free an output spindle from receiving a torque by decreasing a motor current. In another embodiment, the impact driver control system can frees an output spindle from receiving a torque by reversing a motor current.

In an embodiment, an impact driver control system can have an electronic controller which controls the state of a driver control system and the controller can monitor a motor current. The controller can monitor the motor current to identify a driver release condition. When the controller identifies the driver release condition, the driver control system can activate a driver release which frees an output spindle from receiving a torque and the driver release having a driver release current.

In an embodiment, the impact driver control system can have a first driver release current for a first fastener and a second driver release current for a second fastener; wherein the second fastener is different from the first fastener and the first driver release current is different from the second driver release current. In an embodiment, the impact driver control system can have a first driver release current for a first screw and a second driver release current for a second screw; and the second screw can be different from the first screw. In another embodiment, the impact driver control system can have a first driver release current for a first fastener which is a screw and a second driver release current for a second fastener which is different from a screw, the driver release current for the screw can be different from the driver release current for the second fastener.

An impact driver can have an output spindle which is driven by a driving force and an electronic controller can control the state of a driver control system. The electronic controller can monitor a parameter of the impact driver, and the controller can be configured to activate the driver control system to free the output spindle from the driving force when the parameter satisfies a driver release condition.

An impact driver control system can have an electronic controller which controls the state of the driver control system; the electronic controller can monitor a motor current. The electronic controller can monitor the current to identify a driver release condition. The driver release condition having a first decrease of motor current over a first time period followed by a first increase in motor current over a second time period, which is followed by a second decrease of motor current over a third time period followed by a second increase in motor current over a fourth time period; when the controller identifies the driver release condition, the driver control system frees an output spindle from receiving a torque.

An impact driver can have a tool housing which can house a motor and which can also have a handle. The impact driver can have an output spindle which can be configured to hold a tool, such as a bit, and which can be driven by the motor. The impact driver can have an impact mechanism which can be configured to provide impacts to the output spindle and/or an anvil. In an embodiment, an electronic controller can monitor a parameter of the impact driver and which can activate a driver release. The controller can be configured to drive a fastener having a head surface into a workpiece such that the head surface is within a tolerance of flush, such as 4 mm of flush, when the controller activates a driver release, or a tolerance within a range of flush of 1 mm-30 mm, or 1 mm to 20 mm, or 1 mm to 10 mm, or 1 mm to 5 mm, or 1 mm to 3 mm, or less than 1 mm to 2 mm.

In an embodiment, the driver control system can activate a driver release when the head surface of a fastener is flush with a workpiece, or within a tolerance of perfectly flush with a work piece. In an embodiment, the driver control system can activate a driver release when the head surface is within 4 mm of flush of a workpiece surface on at least 80% drive attempts. In an embodiment, the driver control system can activate a driver release when the head surface is within 4 mm of flush on at least 80% of drive attempts. For non-limiting example, the driver control system can activate a driver release in which the controller is configured to drive a 3 inch drywall screw into oak such that the screw head is within 4 mm of flush on at least 80% of drive attempts, or the screw head is within 4 mm of flush on at least 90% of drive attempts, or the screw head is within 3 mm of flush on at least 80% of drive attempts, or the screw head is within 3 mm of flush on at least 90% of drive attempts.

In an embodiment, an impact driver can have a motor which provides a motor force that can drive an impact mechanism and a controller which can be an electronic controller and which controls the state of a driver control system. The controller can monitor a parameter of the impact driver. The controller can be configured to activate the driver control system to free the impact mechanism from the driving force when the parameter satisfies a driver release condition. The driver release condition can correspond to a fastener being driven by the impact driver into a workpiece to a point where it is approximately flush with the workpiece.

In an embodiment, an impact driver can have a motor which provides a force to a bit holder assembly and/or a bit holder. The impact driver can also have a controller which can be an electronic controller and which controls the state of a driver control system. The controller can monitor a parameter of the impact driver. The controller can be configured to activate the driver control system to free the bit holder assembly and/or the bit holder from the driving force when the parameter satisfies a driver release condition; and when the driver release condition corresponds to a fastener being driven by the impact driver into a workpiece to a point where it is approximately flush with the workpiece.

In an embodiment, an impact driver control system can free the impact mechanism and/or the output spindle and/or the bit holder assembly and/or the bit holder from the driving force by reducing the speed of the motor, or reducing the force of the motor, or stopping the motor, or reducing rotation of the motor, or stopping rotation of the motor, or reducing current to the motor, or eliminating current to the motor, or reversing the motor when a fastener being driven by the impact driver into a workpiece to a point where it is approximately flush with the workpiece.

In an embodiment, the impact mechanism can be a rotary impact mechanism. An impact driver can have a tool housing containing a motor and forming a handle. The impact driver can have an output spindle which can be configured to hold a tool and be driven by the motor. The impact driver can have an impact mechanism configured to provide impacts to the output spindle and an electronic controller can monitor a parameter of the impact driver, in which the controller is configured to interrupt driving of a screw into a workpiece when it determines that the screw is flush with the workpiece. In an embodiment, the controller can be an electronic controller in which the current value at which the controller interrupts driving of the screw automatically varies depending upon the screw and the workpiece. In an embodiment, the torque at which the controller interrupts driving of the screw can automatically vary depending upon the screw type and/or fastener type and the workpiece.

An impact driver can have a tool housing which can contain a motor and which can also have a handle. The impact driver can have an output spindle which can be configured to hold a tool, such as a bit, and which can be driven by the motor. An impact mechanism can be configured to provide impacts to the output spindle and/or anvil and an electronic controller can monitor a parameter of the impact driver, in which the controller is configured to interrupt driving of a screw into a workpiece when it determines that the screw is flush with the workpiece based at least partially upon the parameter both prior to the impact mechanism providing impacts to the output spindle and/or anvil and subsequent to the impact mechanism providing impacts to the output spindle and/or anvil.

An impact driver can have a tool housing containing a motor and forming a handle. The impact driver can also have an output spindle configured to hold a tool and be driven by the motor. The impact mechanism can be configured to provide impacts to the output spindle and/or anvil and an electronic controller can monitor a parameter of the impact driver, in which the controller is configured to interrupt driving of a screw into a workpiece when it determines that the screw is flush with the workpiece based at least partially upon the parameter only subsequent to the impact mechanism providing impacts to the output spindle.

An impact driver can have a tool housing containing a motor and forming a handle. The impact driver can also have an output spindle configured to hold a tool and be driven by the motor. The impact driver can have an impact mechanism which can be configured to provide impacts to the output spindle and/or anvil and an electronic controller can monitor at least one parameter of the impact driver, in which the controller is configured to determine when the impact mechanism begins providing impacts to the output spindle; in which the controller is configured to interrupt driving of a screw into a workpiece when it determines that the screw is flush with the workpiece based upon the parameter; and in which the controller is configured to determine that the screw is flush with the workpiece according to a first analysis/algorithm/determination method before it determines that the impact mechanism has begun providing impacts to the output spindle. The controller can be configured to determine that the screw is flush with the workpiece according to a second analysis/algorithm/determination method, different than the first analysis/algorithm/determination method, after it determines that the impact mechanism has begun providing impacts to the output spindle and/or anvil.

An impact driver can have a tool housing containing a motor and forming a handle. The impact driver can have an output spindle configured to hold a tool and be driven by the motor. The impact mechanism can be configured to provide impacts to the output spindle and an electronic controller can monitor at least one parameter of the impact driver, in which the controller is configured to determine when the impact mechanism begins providing impacts to the output spindle and/or anvil. The controller can be configured to interrupt driving of a screw into a workpiece when it determines that the screw is flush with the workpiece based upon the parameter, and in which the at least one parameter used to control driver release comprises at least one of a current, a motor speed and a torque.

The impact driver can have a controller which can have a number of current change limits from which a user can select and set. In an embodiment, an amount of change in a parameter, such as current, speed or torque, can satisfy a driver release condition and activate a driver release. The impact driver can have a switch which can be set to operate the impact driver with the driver control system active, or to set the impact driver to operate using a manual clutch. The impact driver can have a solenoid which frees the output spindle from the driving force, such as a hammer, when the parameter satisfies the driver release condition.

An impact driver can have a motor which can provide a driving force to an impact mechanism and an output spindle transmitting the driving force of the motor to the impact mechanism. The impact driver can also have a controller which can be an electronic controller and which can control the state of a driver control system. The controller can monitor a parameter of the impact driver. The controller can be configured to activate the driver control system to free the output spindle from the driving force when the parameter satisfies a driver release condition. The release activation value of the parameter which satisfies the driver release condition can vary depending upon at least one of a driving condition.

In an embodiment, the impact driver can have a mechanical clutch which can activate if the output spindle continues to turn after the driver control system reduces current to a motor which generates the driving force. In an embodiment, the mechanical clutch can be used to free the impact mechanism from a force. In another embodiment, the mechanical clutch can be used to free the output spindle from a force. In yet another embodiment, the mechanical clutch can be used to free the motor from driving a rotating member, such as an impact mechanism, or an output spindle, or a hammer, or an anvil, or a bit holder assembly, or a bit. In another embodiment, the impact driver can be free of a mechanical clutch.

In an embodiment, the impact driver can have a bit holder assembly and/or bit holder which can receive a driving force. A mechanical release and/or clutch mechanism can free the bit holder assembly and/or the bit holder from the driving force when the parameter satisfies a driver release condition. In an embodiment, the impact driver can have a motor and/or impact mechanism which can provide a driving force to a bit holder assembly and/or a bit holder. The impact driver can also have a controller which can be configured to activate the driver control system to free the bit holder assembly and/or the bit holder from the driving force when the parameter satisfies a driver release condition.

In an embodiment, an impact driver can free an impact mechanism from a driving force by reducing the speed of the motor, or reducing the force of the motor, or stopping the motor, or reducing rotation of the motor, or stopping rotation of the motor, or reducing current to the motor, or eliminating current to the motor, or reversing the motor, when the parameter satisfies a driver release condition.

In an embodiment, the impact driver can have an output spindle transmitting the driving force of the motor to the impact mechanism. When the controller identifies the driver release condition, the driver control system can activate a driver release which frees the output spindle from receiving the driving force.

In an embodiment, an impact driver can have a bit holder assembly and/or a bit holder. The bit holder assembly and/or a bit holder can receive force from the motor. When the controller identifies the driver release condition, the driver control system can activate a driver release which frees the bit holder assembly and/or the bit holder from receiving the driving force.

In an embodiment, an impact driver can free the impact mechanism and/or the output spindle and/or the bit holder assembly and/or the bit holder from the driving force by reducing the speed of the motor, or reducing the force of the motor, or stopping the motor, or reducing rotation of the motor, or stopping rotation of the motor, or reducing current to the motor, or eliminating current to the motor, or reversing the motor, when one or more parameters satisfy a driver release condition, such as a change in current, torque, time or other parameter.

In an embodiment, the impact driver can have a driver release condition having a first decrease of motor current over a first time period followed by a first increase in motor current over a second time period; followed by a second decrease of motor current over a third time period followed by a second increase in motor current over a fourth time period.

In an embodiment, the impact driver can have a having an increase in motor current over each of a number of sequential sampling periods. In an embodiment, the impact driver can have a having an increase in motor current to a value greater than an upper limit of current. In an embodiment, the impact driver can have a having an increase in motor current of greater than a set range, or value, of amperes, such as 0.5 amp or greater, or 1 amp or greater, or 2 amp or greater, or 3 amp or greater, or 5 amp or greater, or 10 amp or greater, or 15 amp or greater.

In an embodiment, the impact driver can have a having a decrease in motor current over each of a number of sequential sampling periods. In an embodiment, the impact driver can have a decrease in motor current to a value lower than a lower limit of current. In an embodiment, the impact driver can have a having a decrease in motor current of greater than 0.25 amp, or greater than 0.5 amp, or greater than 1 amp, or greater than 1.5 amp, or greater than 2 amp, or greater than 3 amp, or greater than 4 amp, or greater than 5 amp, or greater than 10 amp, or greater than 15 amp, or greater than 20 amp.

The impact driver control system can have a first driver release current for a first fastener and a second driver release current for a second fastener; the first fastener can be different from the second fastener. The impact driver control system can have a first driver release current for a first screw and a second driver release current for a second screw; the second screw can be different from the first screw. The impact driver control system can have a first driver release current for a first screw and a second driver release current for a second screw; the second screw can be different from the first screw. The impact driver control system can have a first driver release current for a first fastener which is a first screw and a second driver release current for a second fastener which is different from a screw, the driver release current for the screw can be different from the driver release current for the second fastener.

The impact driver control system can have a first driver release current for a first fastener and a second driver release current for a second fastener; in which the second fastener is different from the first fastener and the first driver release current is different from the second driver release current. The impact driver control system can have a first driver release current for a first fastener and a second driver release current for a second fastener; in which the second fastener is different from the first fastener and the first driver release current is different from the second driver release current.

In an embodiment, an impact driver can free an impact mechanism from a driving force by reducing the speed of the motor, or reducing the force of the motor, or stopping the motor, or reducing rotation of the motor, or stopping rotation of the motor, or reducing current to the motor, or eliminating current to the motor, or reversing the motor, when the parameter satisfies a driver release condition.

In an embodiment, an impact driver can have a mechanical release and/or clutch mechanism which can free the impact mechanism from the driving force when the parameter satisfies a driver release condition.

In an embodiment, an impact driver can have an output spindle which can transmit the driving force of the motor to the impact mechanism. The impact driver can also have a mechanical release and/or clutch mechanism which can free the output spindle from the driving force when the parameter satisfies a driver release condition.

In another embodiment, an impact driver can free an impact mechanism from a driving force by reducing the speed of the motor, or reducing the force of the motor, or stopping the motor, or reducing rotation of the motor, or stopping rotation of the motor, or reducing current to the motor, or eliminating current to the motor, or reversing the motor, when the parameter satisfies a driver release condition.

### BRIEF DESCRIPTION OF THE DRAWINGS

The present invention in its several aspects and embodiments solves the problems discussed above and significantly advances the technology of fastening tools. The present invention can become more fully understood from the detailed description and the accompanying drawings, wherein:

FIG. 1 is a perspective view of an impact driver;

FIG. 2 is a side view of an impact driver;

FIG. 3 is an exploded view of an impact driver;

FIG. 4 is a cross-sectional view of an impact mechanism;

FIG. 5A shows a hammer having a hammer lug being positioned to contact an anvil having an anvil lug;

FIG. 5B shows the hammer lug impacting the anvil lug;

FIG. 5C shows a hammer retracting to allow the hammer lug to clear the anvil lug;

FIG. 5D shows the hammer lug passing across the top of the anvil lug;

FIG. 5E shows the hammer returning to a position to allow a hammer lug to strike the anvil lug;

FIG. 5F is a perspective view of a hammer having multiple hammer lugs and an anvil having multiple hammer lugs;

FIG. 6A shows a fastener at the beginning of its drive sequence;

FIG. 6B shows a fastener midway through its drive sequence;

FIG. 6C shows a fastener at the end of its drive sequence;

FIG. 6D shows a control system configuration which can control a driving sequence;

FIG. 7 provides Table 1 which recites examples of fasteners and workpieces;

FIG. 8 is a data flow chart for an embodiment of an impact driver;

FIG. 9A is a first logic flow chart for embodiments of impact driver logic;

FIG. 9B is a second logic flow chart for additional embodiments of impact driver logic;

FIG. 10 is a graph of raw current data for an example of an impacting phase during the driving of a 3″ drywall screw driven into a pine workpiece;

FIG. 11 is a graph illustrating an example of impact detection;

FIG. 11A shows a current waveform annotated for a hammer impact upon an anvil;

FIG. 12 is an example of a raw current waveform during an impacting drive of a fastener;

FIG. 13 is an example of a driver release (eClutch) reference waveform during an impacting drive of a fastener;

FIG. 14 is a graph illustrating a driver control analysis for driving a 2″ drywall screw driven into a pine workpiece by an impact driver;

FIG. 15 is a graph illustrating a driver control analysis for driving a 1.5″ #8 drywall screw driven into a 2″×4″ pine workpiece by an impact driver;

FIG. 16 is a graph illustrating a driver control analysis for driving a 1.5″ #6 drywall screw into a 2″×4″ pine workpiece by an impact driver;

FIG. 17 is a graph illustrating a driver control analysis for driving a 1.5″ #6 wood screw into a 2″×4″ pine workpiece by an impact driver;

FIG. 18 provides a Table 2 listing the example screws and related data for the examples illustrated in FIGS. 19-27;

FIG. 19 is a graph showing motor current waveforms for four (4) different types of screws being driven by an impact driver;

FIG. 20 is a graph showing average current waveforms for four (4) different types of screws (i.e. Screw 1, Screw 2, Screw 3, Screw 4 of Table 2, FIG. 19) being driven by an impact driver;

FIG. 21 is a graph showing average current slope waveforms for four (4) different types of screws (i.e. Screw 1, Screw 2, Screw 3, Screw 4 of Table 2, FIG. 19) being driven by an impact driver;

FIG. 22 is a graph showing a current waveform for a Screw 5 (i.e. Table 2, FIG. 19) being driven into a pine workpiece and having a release current;

FIG. 23 is a graph showing an average current waveform for a Screw 5 (i.e. Table 2, FIG. 19) being driven into a pine workpiece and having a release current;

FIG. 24 is a graph showing an average current slope waveform for a Screw 5 (i.e. Table 2, FIG. 19) being driven into a pine workpiece and having a release current;

FIG. 25 is a graph showing a current waveform for a Screw 6 (i.e. Table 2, FIG. 19) being driven into a plywood to pine workpiece and having a release current;

FIG. 26 is a graph showing an average current waveform for a Screw 6 (i.e. Table 2, FIG. 19) being driven into a plywood to pine workpiece and having a release current;

FIG. 27 is a graph showing an average current slope waveform for a Screw 6 (i.e. Table 2, FIG. 19) being driven into a pine workpiece; and

FIG. 28 is a table providing current slope and battery voltage for a variety of fasteners driven into a variety of workpieces.

Herein, like reference numbers in one figure refer to like reference numbers in another figure.

### DETAILED DESCRIPTION OF THE INVENTION

The impact driver control system disclosed herein is a long-needed and significant advance in the technology of impact drivers. The impact driver control system achieves the ability to impact drive a single fastener, multiple fasteners of the same type, or multiple fasters of different type accurately, predictably and efficiently. The impact driver control system allows for accurate drive control, as well as control of power output and usage. The impact driver control system can activate a driver release to free an anvil from receiving force when one or more parameters are met and reduces and/or eliminates improper drives of fasteners, stripped or damage fastener heads, damage to workpieces and energy inefficiencies related to impacting during an impact driving of a fastener. The impact driver control system can be used with impact drivers using any power source, such as pneumatic, through a power cord, cordless, solar, or other power type. The impact driver control system can be used with impact drivers which are portable, hand-held, stationary, or part of an automated machine line and/or system.

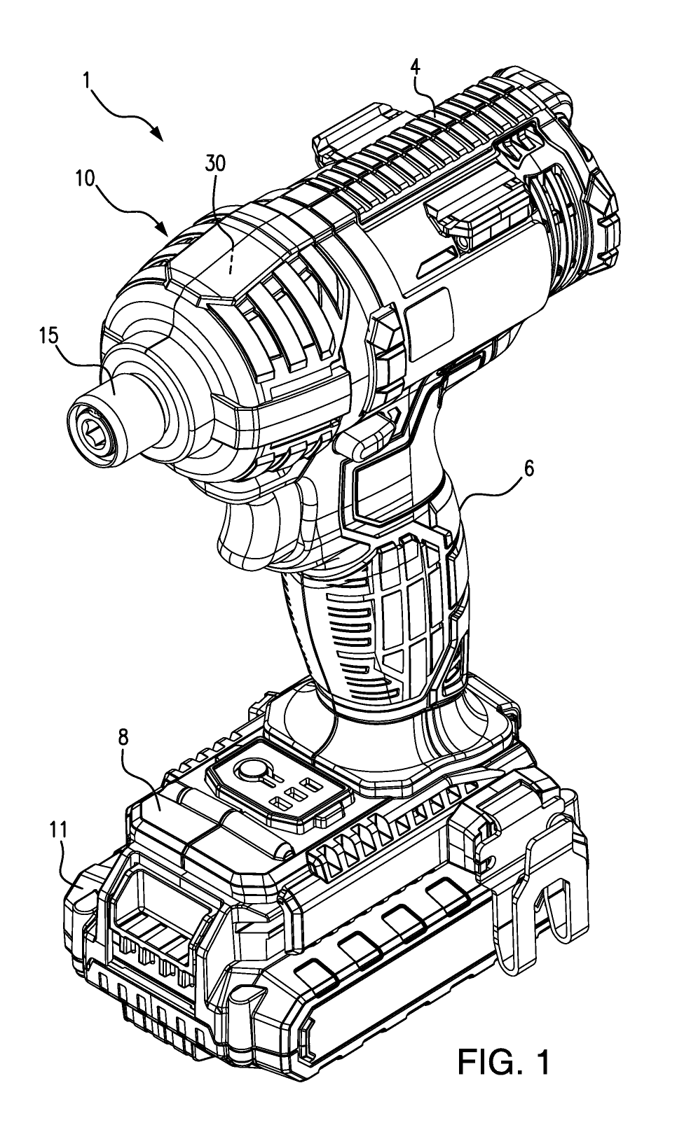

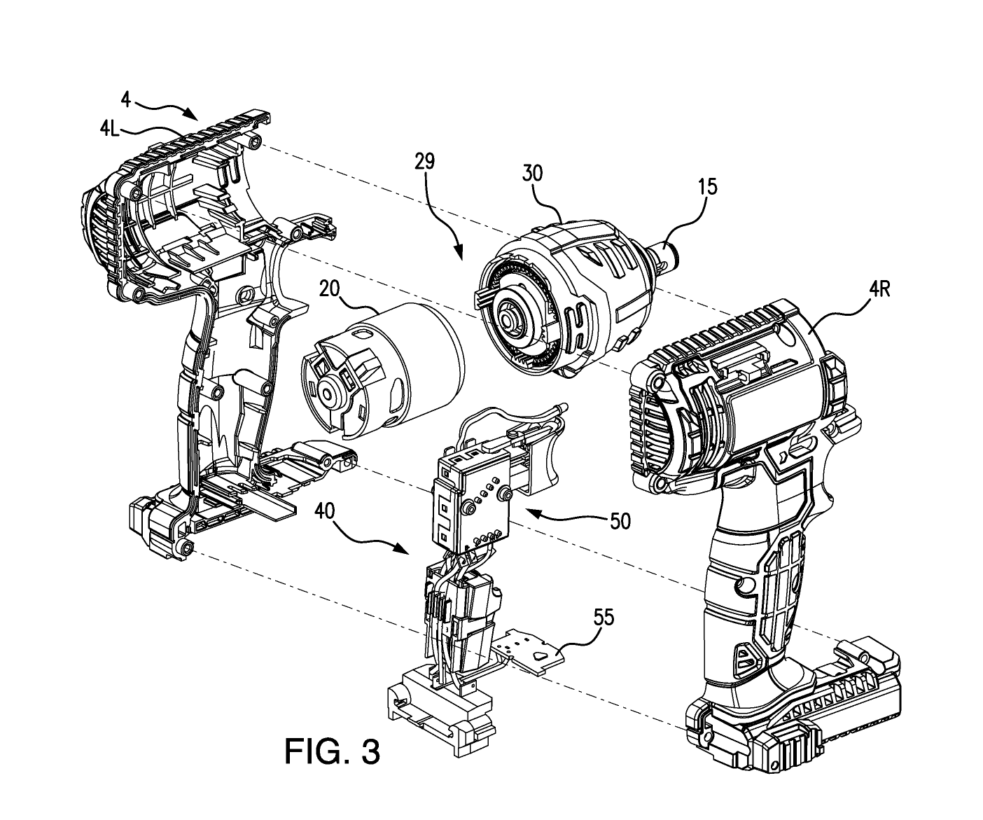

FIG. 1 is a perspective view of an impact driver. FIG. 1 shows an example of a fastening tool 1 which is an impact driver 10 having a housing 4 which houses a motor 20 (FIG. 3), drive mechanism 25 (FIG. 3) and base portion 8 with battery pack 11. The impact driver also has a driver control system 40 (FIG. 3) which can control the motor 20 and a drive mechanism 25 which can have a gearbox 30 and bit holder assembly 15 which can be driven by the drive mechanism 25. In non-limiting example the tool can be a screwdriver bit, a drill bit, or other bit which is compatible with driving a given fastener.

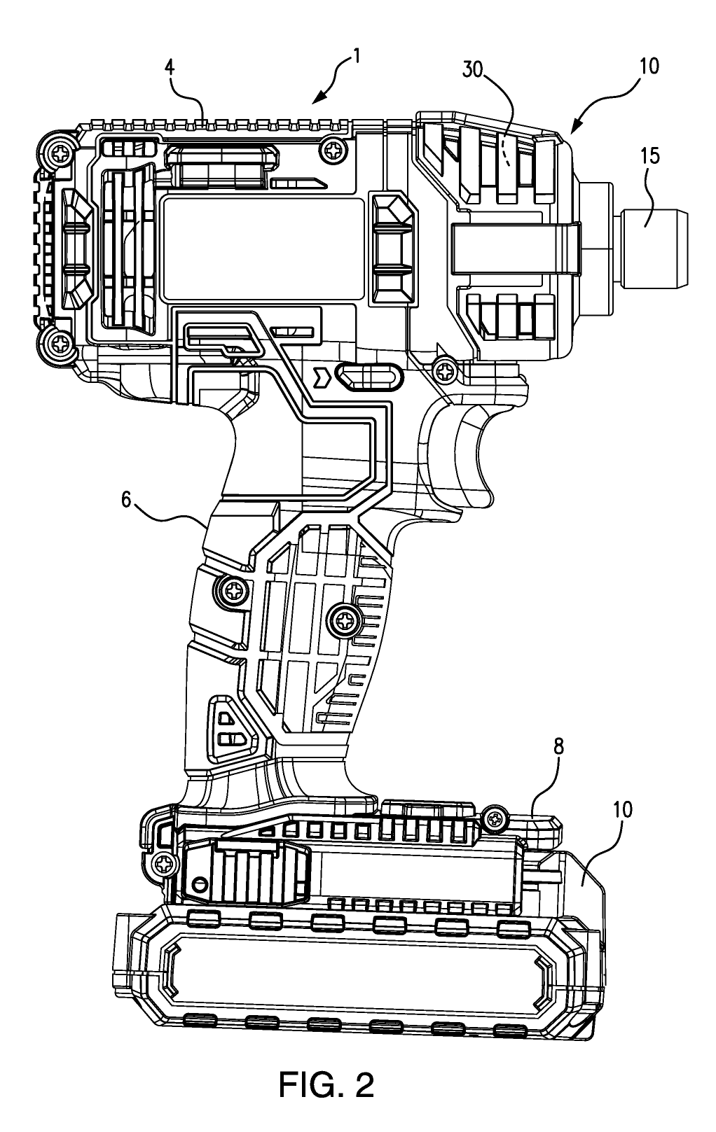

FIG. 2 is a side view of an impact driver. FIG. 2 is a side view of the example impact driver 10 of FIG. 1.

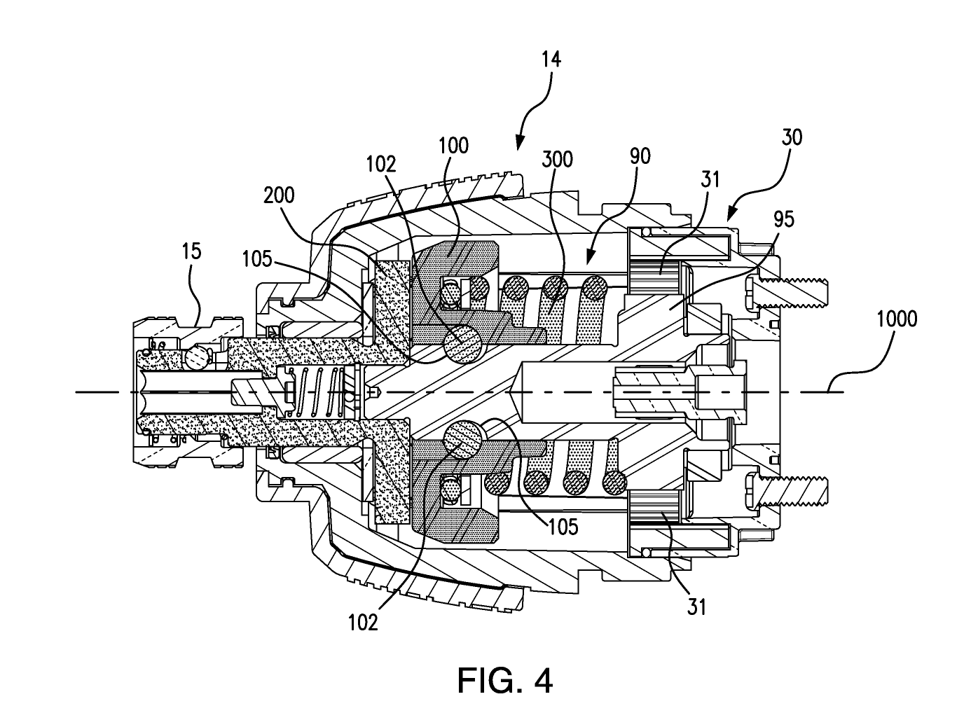

FIG. 3 is an exploded view of an impact driver. FIG. 3 shows the impact driver 10 in an exploded state. FIG. 3 shows the housing 4 having a left housing 4L and a right housing 4R configured to house a drive mechanism 25 having a motor 20, a gearbox 30 and a bit holder assembly 15. The gearbox can have a hammer 100 (FIG. 4) and an anvil 200 (FIG. 4). FIG. 3 also shows a driver control system 40 which can have a switch assembly 50 and a pc board 55.

FIG. 4 is a cross-sectional view of an impact mechanism. FIG. 4 shows a nose housing 14 covering at least in part an impact mechanism 90 which has a gearbox 30, a hammer 100, an anvil 200 and a hammer spring 300. In the embodiment of FIG. 4, the motor 20 provides energy to rotate the output spindle 95 in conjunction with the gears 31 of gearbox 30. In the embodiment of FIG. 4, the rotation of output spindle 95 imparts energy to the hammer 100 which energizes the hammer 100 to rotate. Optionally, one or more of a hammer bearing 102 can be used to guide the motion of the hammer 100 and can facilitate the axial motion of the hammer 100 along a length of an output spindle centerline 1000 and, optionally, a hammer guide groove 105. The rotating hammer 100 can impart energy to the anvil 200 to achieve a rotational motion of the anvil 200. The rotational motion of the anvil 200 can cause a tool, such as a bit which can be held in the bit holder assembly 15, to turn. The turning of the tool, such as a bit, when applied to a fastener can drive the fastener into a work piece. An impact driver can have a portion of a driving sequence for a fastener which is an impacting phase.

When a resistance to turning of a fastener reaches an hammer retraction resistance, the hammer 100 will move axially away from a portion of the anvil base 202 along output spindle axis 1000 with the guidance of one or more hammer bearings 102 and the guide groove 105 and be allowed to clear the anvil in a manner in which the hammer 100 can rotate faster than the anvil 200 for at least a part of a revolution of the hammer 100. Then, the hammer 100 can move axially along output spindle axis to return to a position to impact against and impart rotational energy to anvil 200. This impacting sequence can be repeated until a driver release condition exists, or the trigger is released.

Herein the term “driver release” is to be broadly construed. A “driver release” means any control action, event or occurrence in which the impact driver control system causes a decrease, reduction or elimination of force, energy, torque or motion from a drive mechanism, such as a hammer, upon an output spindle and/or anvil during an impacting phase. A “driver release” can be caused by a broad variety of factors, such as the impact driver control system causing a reduction in energy, current, motor current, motor speed, output spindle speed, hammer speed, torque or force, upon the output spindle and/or anvil. A “driver release” can also mean a slowing and/or stopping of the motor of an impact driver by reducing the current it receives, reversing the polarity and/or direction of the current the motor receives, or employing electrical and/or mechanical means to slow and/or stop the motor.

A “driver release” can also mean a slowing and/or stopping of the motor of an impact driver by reducing the current it receives, reversing the polarity and/or direction of the current the motor receives, or employing electrical and/or mechanical means to slow and/or stop the motor in an amount sufficient to interrupt, reduce, suspend or stop the impacting of an impact driver, such as in non-limiting example to interrupt, reduce, suspend or stop the impacting of a hammer upon an anvil. A “driver release” can also mean a slowing and/or stopping of the motor of an impact driver by reducing the current it receives, reversing the polarity and/or direction of the current the motor receives, or employing electrical and/or mechanical means to slow and/or stop the motor in an amount sufficient to interrupt, reduce, suspend or stop the impacting of an impact driver, such as in non-limiting example to interrupt, reduce, suspend or stop the driving and/or turning and/or rotating of a fastener. The term “driver release” can also encompass the impact driver control system reducing motor speed and/or stopping the motor and/or reducing the supply power to the motor and/or stopping the supply power to the motor and/or coasting the motor and/or braking the motor and/or turning off the motor drive system and/or changing motor direction and/or any control method that can control motor speed and/or power and/or direction. A “driver release” can also mean reversing the direction of rotation of a motor or driving force or means upon the output spindle and/or anvil. A “driver release” can also mean activating an electrical, mechanical, electromechanical, or magnetic means to disengage the output spindle and/or anvil from a driving force or means, or to reduce the energy imparted from a driver force or means.

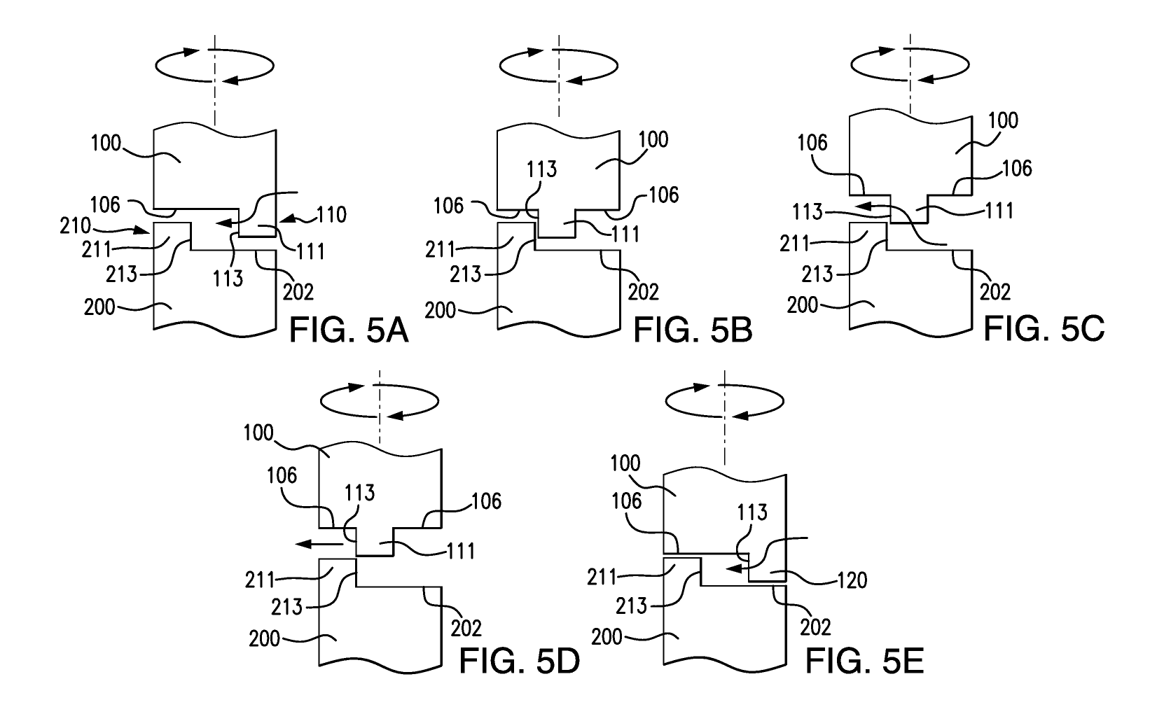

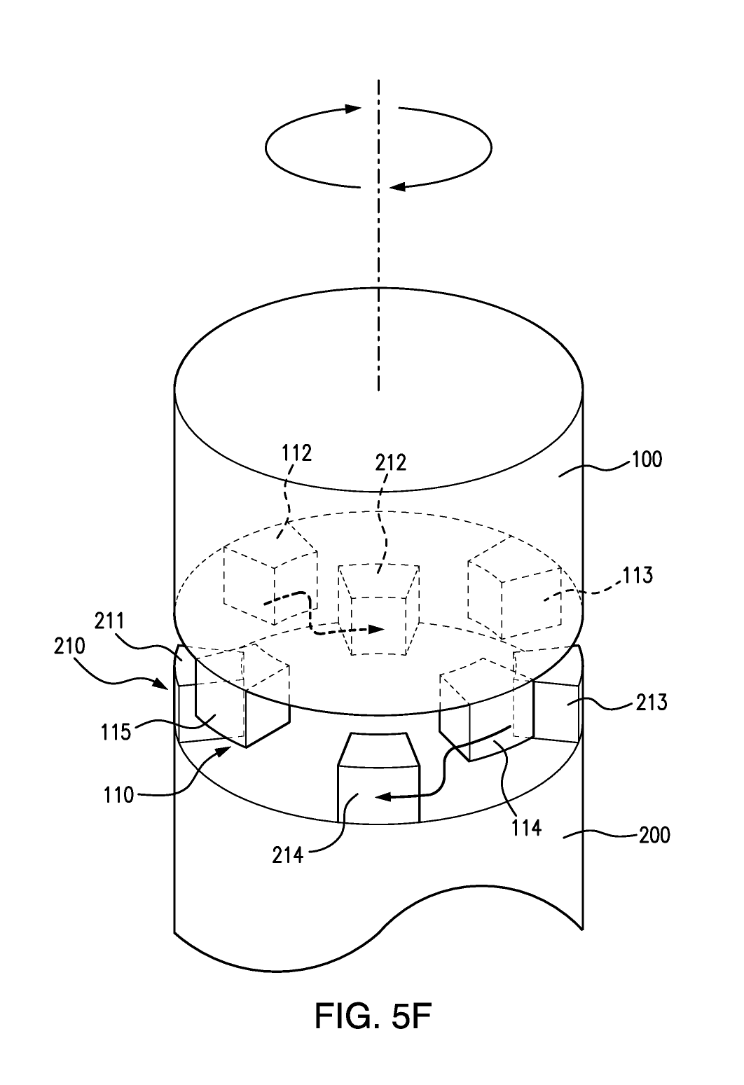

FIG. 5A shows a hammer 100 having a hammer lug 110 being positioned to contact an anvil having an anvil lug 210.

FIG. 5A shows a hammer 100 having a hammer surface 106 from which one or more of a hammer lug 110 can project. A first hammer lug 111 is shown in FIG. 5A has a first hammer lug face 113. A first anvil lug 211 having a first anvil lug face 213.

FIG. 5B shows the hammer lug impacting an anvil lug. FIG. 5B shows the first hammer lug 100 rotating toward the first anvil lug 211 such that the first hammer lug face 113 will impact first anvil lug face 213.

FIG. 5C shows a hammer retracting to allow the hammer lug to clear the anvil lug. When the resistance to rotation reaches a hammer retraction resistance the hammer 100 will move axially away from a portion of the anvil base 202 along the output spindle axis 1000 such that the first hammer lug 110 can clear the first anvil lug 211.

FIG. 5D shows the hammer lug passing across the top of the anvil lug.

FIG. 5D shows the first hammer lug 111 clearing and rotationally passing across the first anvil lug 211.

FIG. 5E shows the hammer returning to a position to allow the hammer lug to strike the anvil lug.

In the embodiment of FIGS. 5A-5E, the hammer has a number of the hammer lug 110. FIG. 5E show a second hammer lug 120 having a second hammer lug face 122 moving into position rotationally and axially along the output spindle axis 1000 into a configuration to strike the first anvil lug 211.

The process of one or more, or a series, of a hammer lug 110, such as the first hammer lug 111, the second hammer lug 120, a third hammer lug 130 and a fourth hammer lug 140, striking an anvil lug 210 can be repeated until the driving of the hammer is released. There is no limit to the number of lugs which a hammer can have. There is also no limit to the lugs an anvil can have, such as the first anvil lug 211, a second anvil lug 220, a third anvil lug 230 and a fourth anvil lug 240.

FIG. 5F is a perspective view of a hammer having multiple hammer lugs and an anvil having multiple hammer lugs.

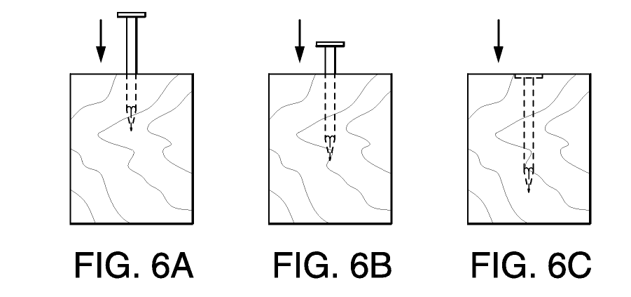

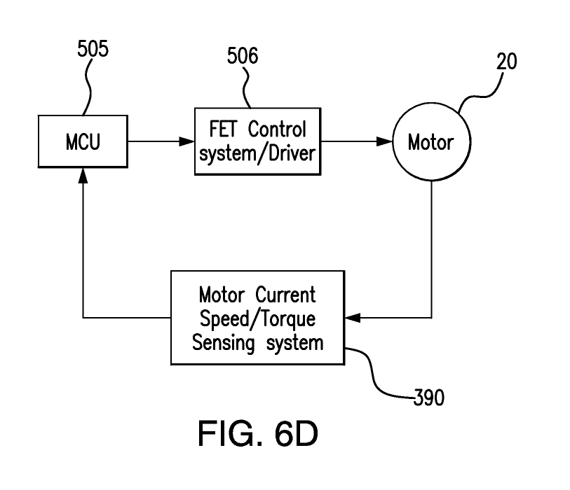

FIGS. 6A-6C show three example phases of driving a fastener, such as a screw, by an impact driver. Herein the full action of driving a fastener from start to finish is referred to as a drive sequence.

FIG. 6A shows a fastener at the beginning of its driving sequence.

FIG. 6B shows a fastener midway through its driving sequence.

FIG. 6C shows a fastener at the end of it driver sequence.

FIG. 6D shows a control system configuration which can control the driving of a fastener through its driving sequence.

FIG. 6D illustrates a motor 20 having one or more sensors 400 which are used by a sensing system 390 and which can sense data regarding a variety of impact driver parameters such as current, speed, torque, temperature, sound, vibration. The counting of occurrences and events can also be parameters measured by the impact driver control system.

Numeric values and ranges herein, unless otherwise stated, are intended to have associated with them a tolerance and to account for variances of design and manufacturing. Thus, a number can include values “about” that number. For example, a value X is also intended to be understood as “about X”. Likewise, a range of Y to Z, is also intended to be understood as within a range of from “about Y to about Z”. Additionally, example numbers disclosed within ranges are intended also to disclose sub-ranges within a broader range which have an example number as an endpoint. A disclosure of any two example numbers which are within a broader range is also intended herein to disclose a range between such example numbers. Unless otherwise stated, significant digits disclosed for a number are not intended to make the number an exact limiting value. Variance and tolerance is inherent in mechanical design and the numbers disclosed herein are intended to be construed to allow for such factors (in non-limiting e.g., ±10 percent of a given value). Likewise, the claims are to be broadly construed in their recitations of numbers and ranges.

In an embodiment the parameter can be a current in the range of 1.5 amp to 50 amp, or 5 amp to 40 amp, or 5 amp to 30 amp, or 5 amp to 25 amp, or 5 amp to 30 amp, or 7.5 amp to 30 amp, or 7.5 amp to 25 amp, or 9 amp to 30 amp, or 9 amp to 25 amp, or 5 amp to 23 amp. In non-limiting example the parameter can be a current of 8 amp, 9 amp, 10 amp, 11 amp, 12 amp, 13 amp, 14 amp, 15 amp, 17 amp, 18 amp, 20 amp, 21 amp, 22 amp, 23 amp, 24 amp, 25 amp. In another non-limiting example the current can be a current of 5 amp or greater, or 10 amp or greater, or 15 amp or greater, or 20 amp or greater, or 25 amp or greater, or 30 amp or greater, or 40 amp or greater.

In an embodiment the parameter can be a motor current in the range of 1.5 amp to 50 amp, or 5 amp to 40 amp, or 5 amp to 30 amp, or 5 amp to 25 amp, or 5 amp to 30 amp, or 7.5 amp to 30 amp, or 7.5 amp to 25 amp, or 9 amp to 30 amp, or 9 amp to 25 amp, or 5 amp to 23 amp. In non-limiting example the parameter can be a current of 8 amp, 9 amp, 10 amp, 11 amp, 12 amp, 13 amp, 14 amp, 15 amp, 17 amp, 18 amp, 20 amp, 21 amp, 22 amp, 23 amp, 24 amp, or 25 amp. In another non-limiting example the parameter can be a motor current of 5 amp or greater, or 10 amp or greater, or 15 amp or greater, or 20 amp or greater, or 25 amp or greater, or 30 amp or greater, or 40 amp, or greater.

In an embodiment the parameter can be a battery current in the range of 1.5 amp to 50 amp, or 5 amp to 40 amp, or 5 amp to 30 amp, or 5 amp to 25 amp, or 5 amp to 30 amp, or 7.5 amp to 30 amp, or 7.5 amp to 25 amp, or 9 amp to 30 amp, or 9 amp to 25 amp, or 5 amp to 23 amp. In non-limiting example the parameter can be a current of 8 amp, 9 amp, 10 amp, 11 amp, 12 amp, 13 amp, 14 amp, 15 amp, 17 amp, 18 amp, 20 amp, 21 amp, 22 amp, 23 amp, 24 amp, or 25 amp. In another non-limiting example the parameter can be a battery current of 5 amp or greater, or 10 amp or greater, or 15 amp or greater, or 20 amp or greater, or 25 amp or greater, or 30 amp or greater, or 40 amp, or greater.

In an embodiment the parameter can be an average current in the range of 1.5 amp to 50 amp, or 5 amp to 40 amp, or 5 amp to 30 amp, or 5 amp to 25 amp, or 5 amp to 30 amp, or 7.5 amp to 30 amp, or 7.5 amp to 25 amp, or 9 amp to 30 amp, or 9 amp to 25 amp, or 5 amp to 23 amp. In non-limiting example the parameter can be a current of 8 amp, 9 amp, 10 amp, 11 amp, 12 amp, 13 amp, 14 amp, 15 amp, 17 amp, 18 amp, 20 amp, 21 amp, 22 amp, 23 amp, 24 amp, 25 amp. In another non-limiting example the parameter can be an average current of 5 amp or greater, or 10 amp or greater, or 15 amp or greater, or 20 amp or greater, or 25 amp or greater, or 30 amp or greater, or 40 amp or greater.

In an embodiment the parameter can be an average motor current in the range of 1.5 amp to 50 amp, or 5 amp to 40 amp, or 5 amp to 30 amp, or 5 amp to 25 amp, or 5 amp to 30 amp, or 7.5 amp to 30 amp, or 7.5 amp to 25 amp, or 9 amp to 30 amp, or 9 amp to 25 amp, or 5 amp to 23 amp. In non-limiting example the parameter can be a current of 8 amp, 9 amp, 10 amp, 11 amp, 12 amp, 13 amp, 14 amp, 15 amp, 17 amp, 18 amp, 20 amp, 21 amp, 22 amp, 23 amp, 24 amp, 25 amp. In another non-limiting example the parameter can be an average motor current of 5 amp or greater, or 10 amp or greater, or 15 amp or greater, or 20 amp or greater, or 25 amp or greater, or 30 amp or greater, or 40 amp or greater.

In an embodiment the parameter can be a current slope in the range of −30 amp/t to 30 amp/t, or −15 amp/t to 15 amp/t, or −10 amp/t to 10 amp/t, or −2 amp/t to 2 amp/t.

In an embodiment the parameter can be a motor current slope in the range of −30 amp/t to 30 amp/t, or −15 amp/t to 15 amp/t, or −10 amp/t to 10 amp/t, or −2 amp/t to 2 amp/t.

In an embodiment the parameter can be a positive current slope in the range of 0.01 amp/t to 30 amp/t, or 0.01 amp/t to 15 amp/t, or 0.01 amp/t to 10 amp/t, or 0.01 amp/t to 2 amp/t.

In an embodiment the parameter can be a positive motor current slope in the range of 0.01 amp/t to 2 amp/t, or 5 amp/t to 15 amp/t, or 2 amp/t to 10 amp/t, or 0.01 amp/t to 30 amp/t.

In an embodiment the parameter can be a negative current slope in the range of −30 amp/t to −0.01 amp/t, or −15 amp/t to −0.01 amp/t, or −10 amp/t to −0.01 amp/t, or −2 amp/t to −0.01 amp/t.

In an embodiment the parameter can be a negative motor current slope in the range of −30 amp/t to −0.01 amp/t, or −15 amp/t to −0.01 amp/t, or −7 amp/t to −0.01 amp/t, or −2 amp/t to −0.01 amp/t.

The impact driver control system comprising a driver release current in the range of 1.5 amp to 50 amp, or 5 amp to 40 amp, or 5 amp to 30 amp, or 5 amp to 25 amp, or 5 amp to 30 amp, or 7.5 amp to 30 amp, or 7.5 amp to 25 amp, or 9 amp to 30 amp, or 9 amp to 25 amp, or 5 amp to 23 amp. In non-limiting example the parameter can be a current of 8 amp, 9 amp, 10 amp, 11 amp, 12 amp, 13 amp, 14 amp, 15 amp, 17 amp, 18 amp, 20 amp, 21 amp, 22 amp, 23 amp, 24 amp, 25 amp. In another non-limiting example the driver release current can be a current of 5 amp or greater, or 10 amp or greater, or 15 amp or greater, or 20 amp or greater, or 25 amp or greater, or 30 amp or greater, or 40 amp or greater.

In an embodiment, the impact driver can monitor a parameter which is a motor speed in a range of 1,500 rpm to 50,000 rpm, or 2,200 rpm to 45,000, or 3,500 rpm to 45,000, or 5,000 rpm to 45,000, or 7,500 rpm to 22,000, or 10,000 rpm to 18,000, or 12,000 rpm to 25,000, or 15,000 rpm to 25,000, or 18,000 rpm to 30,000, or 20,000 rpm to 35,000, or 23,000 rpm to 40,000, or 25,000 rpm to 40,000, or 30,000 rpm to 40,000, or 33,000 rpm to 45,000, or 35,000 rpm to 50,000. For additional example, the parameter can be a speed of 3,300 rpm, 3,500 rpm, 7,500 rpm, 12,000 rpm, 15,000 rpm, 17,500 rpm, 20,000 rpm, 22,000 rpm, 25,000 rpm, 30,000 rpm, 40,000 rpm, 50,000 rpm, or greater.

In an embodiment, the impact driver can monitor a parameter which is a hammer 100 speed in a range of 1,500 rpm to 50,000 rpm, or 2,200 rpm to 45,000, or 3,500 rpm to 45,000, or 5,000 rpm to 45,000, or 7,500 rpm to 22,000, or 10,000 rpm to 18,000, or 12,000 rpm to 25,000, or 15,000 rpm to 25,000, or 18,000 rpm to 30,000, or 20,000 rpm to 35,000, or 23,000 rpm to 40,000, or 25,000 rpm to 40,000, or 30,000 rpm to 40,000, or 33,000 rpm to 45,000, or 35,000 rpm to 50,000. For additional example, the parameter can be a speed of 3,300 rpm, 3,500 rpm, 7,500 rpm, 12,000 rpm, 15,000 rpm, 17,500 rpm, 20,000 rpm, 22,000 rpm, 25,000 rpm, 30,000 rpm, 40,000 rpm, 50,000 rpm, or greater.

In an embodiment, the impact driver can monitor a parameter which is an output spindle 95 speed in a range of 1,500 rpm to 50,000 rpm, or 2,200 rpm to 45,000, or 3,500 rpm to 45,000, or 5,000 rpm to 45,000, or 7,500 rpm to 22,000, or 10,000 rpm to 18,000, or 12,000 rpm to 25,000, or 15,000 rpm to 25,000, or 18,000 rpm to 30,000, or 20,000 rpm to 35,000, or 23,000 rpm to 40,000, or 25,000 rpm to 40,000, or 30,000 rpm to 40,000, or 33,000 rpm to 45,000, or 35,000 rpm to 50,000. For additional example, the parameter can be a speed of 3,300 rpm, 3,500 rpm, 7,500 rpm, 12,000 rpm, 15,000 rpm, 17,500 rpm, 20,000 rpm, 22,000 rpm, 25,000 rpm, 30,000 rpm, 40,000 rpm, 50,000 rpm, or greater.

In an embodiment, the impact driver can monitor a parameter which is an amount of torque imparted from a hammer to an anvil in a range of 10 in/lbs to 10000 in/lbs, or 50 in/lbs to 1500 in/lbs, or 500 in/lbs to 1500 in/lbs, or 100 in/lbs to 1000 in/lbs.

In an embodiment, the impact driver can monitor a parameter which is an amount of motor torque imparted from a hammer to an anvil in a range of 10 in/lbs to 10000 in/lbs, or 150 in/lbs to 1500 in/lbs, or 1250 in/lbs to 10000 in/lbs, or 3000 in/lbs to 7000 in/lbs, or 5000 in/lbs to 10000 in/lbs, or 150 in/lbs to 6000 in/lbs.

In an embodiment, the impact driver can monitor a parameter which is a motor torque, as a set point for driver release. In an embodiment, the impact driver can monitor a parameter which is a current, as a set point for driver release. In an embodiment, the impact driver can monitor a parameter which is a motor speed, as a set point for driver release. In an embodiment, the impact driver can monitor a parameter which is a hammer speed, as a set point for driver release. In an embodiment, the impact driver can monitor a parameter which is the output spindle speed, as a set point for driver release.

Sensors which can be used by the driver control system are for non-limiting example, a current sensor 401, a motor current sensor 403, battery current sensor 405, motor speed sensor 421, output spindle speed sensor 423, hammer speed sensor 425, anvil speed sensor 427, or torque sensor 440. Other sensors, such as vibration and noise sensors, can also be used.

The sensing system 390 can provide data to driver control system 500 which can have a motor control unit (“MCU”) 505 which can use a FET-type controller 506, such as a MOSFET, to control the motor.

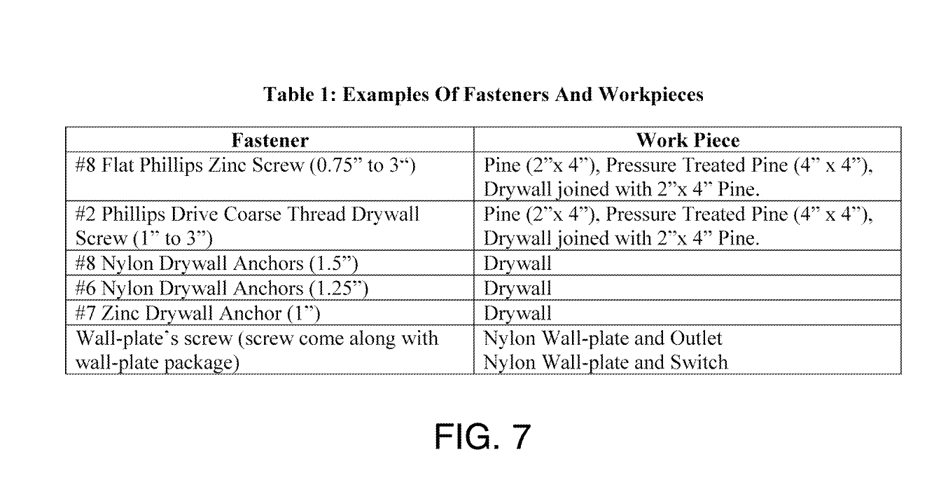

FIG. 7 provides Table 1 which recites examples of fasteners and workpieces. Any fastener suitable for driving by an impact driver can be driving by using the impact driver control system disclosed herein. Table 7 provides non-limiting example of fasteners and objects which can be driven by the impact driver having the impact driver control system disclosed herein, such as: threaded fasteners, screws, Philips head screws, flat head screws, hex screws, cheese head screw, other headed screws, wood screws, lag screws, decking screw, machine screws, thread cutting machine screws, sheet metal screws, screws which can be turned by a bit, set screws, eye bolts, eye lags, socket type screws, self-tapping screws, self-drilling screws, headless screws, drywall screws, bolts, carriage bolt, self-drilling SMS bolts, hex bolts, heavy hex bolts, lag bolts, shoulder bolts, headless bolts, cheese head bolt, nuts, hex nut, heavy hex nut, lock nut, jam nut, wing nut, cap nut, acorn nut, flange nut, tee nut, square nut, torque lock nut, fasteners with any of the following heads flat, oval, pan, trus, round, hex, hex washer, slotted hex washer, socket cap, button, Phillips, Fearson, slotted, combination, socket, Allen, one way, square, torx.

Any of these fasteners can have any length, such as in non-limiting example 0.5 in or greater, or 1.0 in or greater, 1.5 in or greater, or 2.0 in or greater, or 2.5 in or greater, or 3.0 in greater, or 4.0 in or greater, or 6.0 in or greater, and can be driven by the impact driver control system. The impact driver control system can drive any sequence or combination of any fastener which can be driver by an impact driver whether the sequential fasteners driver are the same or different. The sequential fasteners can differ in length, diameter, treading, head type, fastener type, or other difference which can exist between two fasteners.

In addition to driving fasteners, the impact driver having a driver control system can also be used to loosen fasteners from a workpiece or free stuck fasteners from a workpiece.

A broad variety and wide range of workpieces can be use, such as for non-limiting example wood, metal, concrete, ceramic, glass, plastic, composites, laminates and other materials into which impact drivers drive fasteners. In an embodiment, a fastener can be driven into a pine workpiece, pine board, 2″×4″ pine lumber, plywood, drywall, or other type of workpiece.

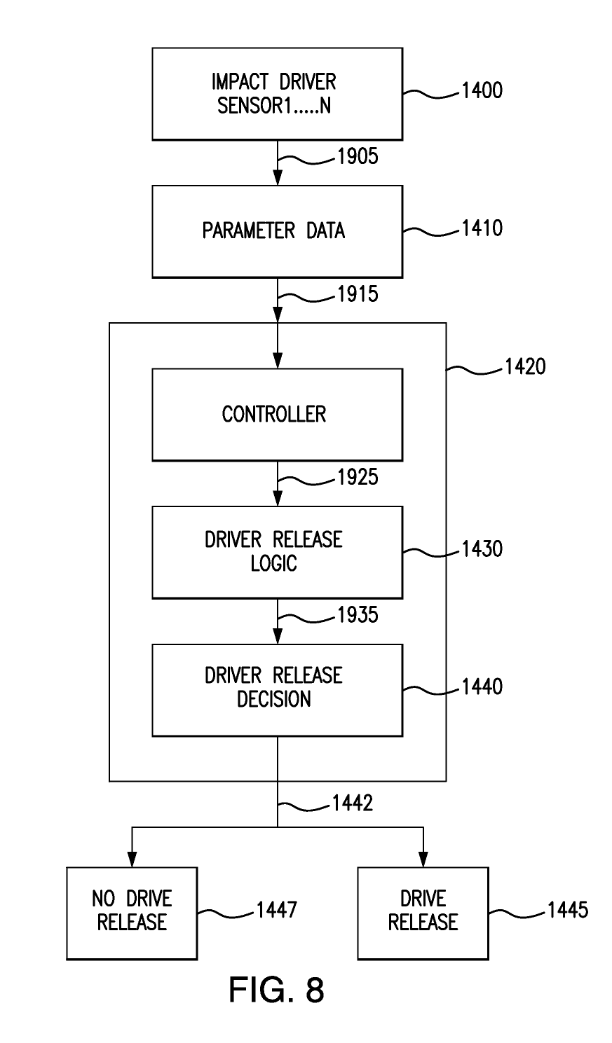

FIG. 8 is a data flow chart for an embodiment of an impact driver. FIG. 8 provides an example of a data flow for an embodiment of the impact driver control system in which one or more of an impact driver sensor 1400, e.g. 1 . . . n sensors, provide a sensor data stream 1405 which can communicate parameter data 1410 via a parameter data stream 1415 to a controller 1420 which can process the data stream 1415 producing controller data stream 1425. Controller 1420 can execute driver release logic 1430 producing logic data stream 1435 and can produce a driver release decision 1440. The driver release decision 1440 can be a decision to activate a driver release to free the anvil 200 from additional torque or to lower or stop the rotational forces upon the anvil 200. Alternately, the driver release decision can be to continue impacting upon the anvil.

Herein, the impact driver control system and any system and/or software disclosed can execute rule-based logic and/or other processing and/or other decision making by processing and/or using a single parameter and/or criterion and/or data or a plurality of parameter, criterion or data. There is no limitation to the upper number, type or variety of parameter, criteria or data which can be used.

Herein, the “impact driver control system” is a very broad term which in addition to its ordinary and customary meaning means and encompasses a software application which processes, holds, has or manages data associated with an impact driver, driver mechanism, sensors, switches, electrical elements, mechanical elements and any element, feature or characteristic which can be used to control any aspect of an impact driver related to or which can affect any aspect of a an impact driver, driving, drive mechanism, drive performance, or other aspect of an impact driver which can relate to or affect any aspect of tool performance. Additionally, “impact driver control system” additionally encompasses any hardware and software which processes data and program executable code to control one or more aspects of the driver mechanism and driver performance.

The “impact driver control system” additionally encompasses computer executable code and computer executable code for executing rule based logic. Such computer executable code and logic can monitor and/or control impact driver functions and characteristics. These computer program instructions can be loaded onto a general purpose computer, electronic controller, microcontroller, MCU, special purpose computer, or other programmable data processing apparatus to achieve a control system, such that the instructions which execute on the computer or other programmable data processing apparatus create means for implementing the functions and actions specified and disclosed herein.

These computer program instructions can also be stored in a computer-readable memory that can direct a computer or other programmable data processing apparatus to function in a manner such that the instructions stored in the computer-readable memory produce an article of manufacture that can be configured for implementing the functions and actions disclosed herein. The computer program instructions can also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions and actions specified herein

Additionally, the impact driver can be wireless and/or Bluetooth enabled. The wireless and/or Bluetooth functionality allows the impact driver to communication any data of the impact driver control system to another device. Transmission of data from the impact driver for processing by one or more devices external to the impact driver allows users, technologists, managers and others to monitor tool performance, make decisions and manage operations.

In an embodiment a driver release decision can result in decreasing motor current, reversing motor current, slowing motor speed, reversing motor direction, mechanically releasing anvil from application of torque, mechanically releasing one or more portions of the drive mechanism to allow anvil to reduce rotation and/or stop rotating and/or be free of impacts from the hammer.

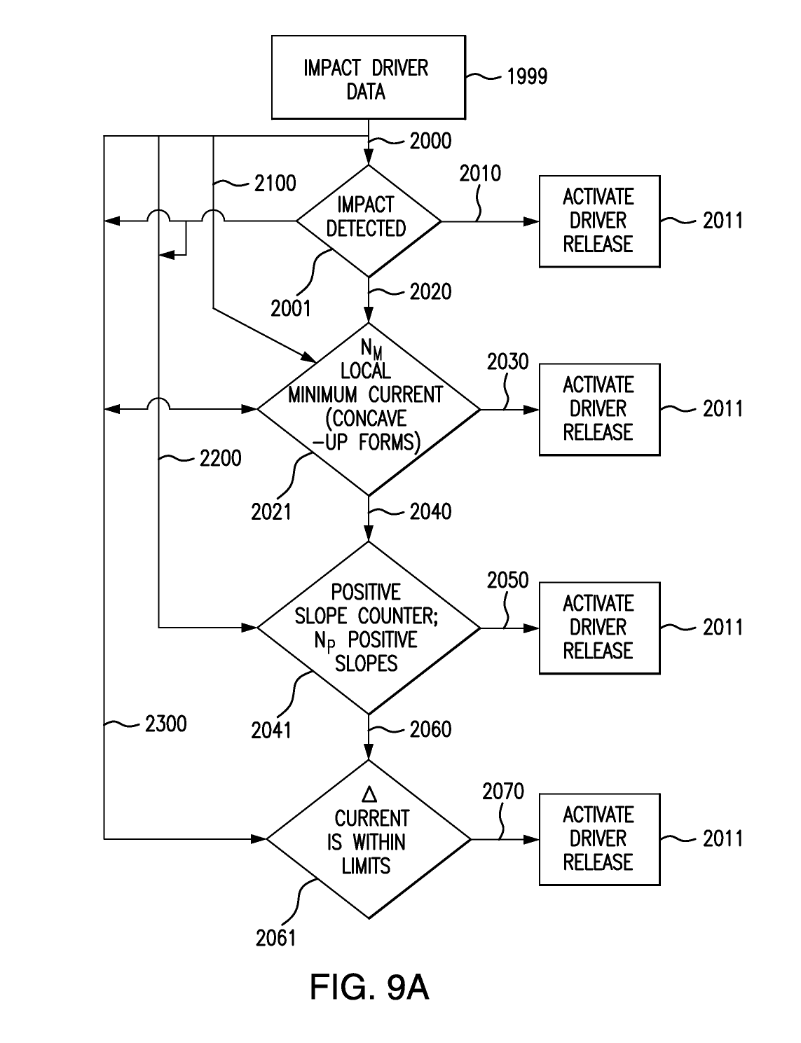

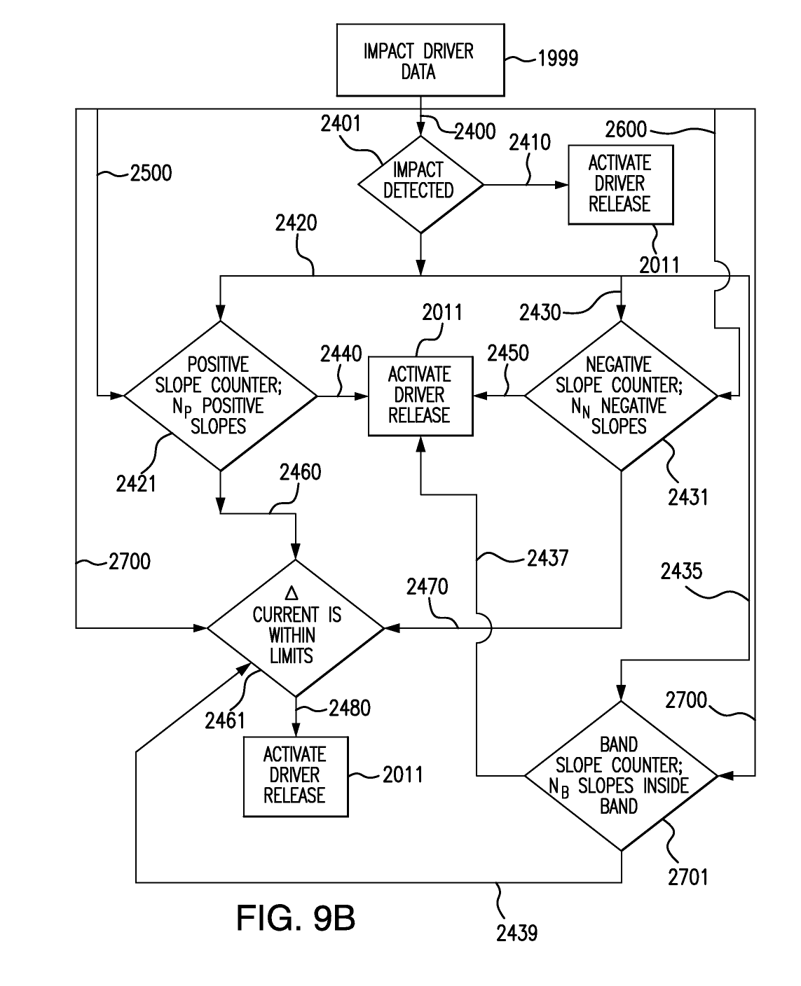

FIG. 9A is a logic flow chart for a first embodiment of impact driver logic. The driver control system can execute program executable code of logical decision making to control the drive system. The driver control system can maintain impacting conditions, modify the speed of the drive system and the nature of the hammer 100 impacts upon the anvil 200, as well as free the anvil 200 from impacts by the hammer 100. In an embodiment, the driver control system can control the motor current to the motor 20, or can stop or reverse the direction of the applied current and rotation of the motor. In an embodiment, the driver control system can control the speed of rotation of the motor, as well as stopping the rotation of the motor. In an embodiment, the driver control system can control the direction of rotation of the motor.

The driver control system can activate a driver release as a result of a number of conditions and logical pathways. As shown in FIG. 9A, if the impact data 1999 of data stream 2000 indicate an impact detected 2020 condition an instruction 2010 can activate a driver release 2011. In another embodiment if the impact data 1999 of data stream 2100 indicates Nm instances of a local minimum current 2021, such as Nm concave-up waveforms, then an instruction 2030 can activate a driver release 2011. In yet embodiment, if the impact data 1999 of data stream 2200 indicates Np instances of positive slope showing current increase 2041 as processed by a positive slope showing current increase counter then an instruction 2050 can activate a driver release 2011. In a further embodiment, if the impact data 1999 of data stream 2300 indicates a change in current within boundary limits 2061 then an instruction 2070 can activate a driver release 2011.

As shown in FIG. 9A, a combination of conditions can result in the activation of a driver release 2011. The combination of conditions can be along the logical paths shown in FIGS. 9A and 9B. For example, the driver control system can activate a driver release when data indicates an impacted detected 2001 condition followed by one or more of an Nm instances of a local minimum current 2021, Np instances of positive slope showing current increase 2041 and a change in current within boundary limits 2061.

In another embodiment, the driver control system has no need to identify an impact detected 2001 condition and can monitor directly for one or more of an Nm instances of a local minimum current 2021, Np instances of positive slope showing current increase 2041 and a change in current within boundary limits 2061 to activate a driver release.

The impact driver can have a having a change in the motor current, wherein the change in current is less than a current change limit over a period of time greater than 1 ms or greater, or 10 ms or greater, or 25 ms or greater, or 50 ms or greater, or 75 ms or greater, or 150 ms or greater, or 200 ms or greater, or 250 ms or greater, or 300 ms or greater, or 400 ms or greater, or 500 ms or greater, or 1000 ms or greater, or 2000 ms or greater, or 5000 ms or greater, or 10000 ms or greater.

The impact driver can have a having a change in the motor current, wherein the change in current is less than a current change limit over a number of sampling periods.

The impact driver can have a having a change in the motor current, wherein the current remains within an upper limit of current and a lower limit of current over a period of time greater than 1 ms or greater, or 10 ms or greater, or 25 ms or greater, or 50 ms or greater, or 75 ms or greater, or 150 ms or greater, or 200 ms or greater, or 250 ms or greater, or 300 ms or greater, or 400 ms or greater, or 500 ms or greater, or 1000 ms or greater, or 2000 ms or greater, or 5000 ms or greater, or 10000 ms or greater.

The impact driver can have a having a change in the motor current, wherein the current remains within an upper limit of current and a lower limit of current over a number of sampling periods.

FIG. 9B is a logic flow chart for a second embodiment of impact driver logic. FIG. 9B shows a number of additional logical pathways which can be used by the driver control system to activate a driver release. If the impact data 1999 of data stream 2400 indicate an impact detected 2410 condition an instruction 2410 can activate a driver release 2011. In an embodiment, if Np instances of positive slope showing current increase 2041 is detected an instruction 2440 can activate a driver release 2011. In another embodiment, if Nn instances of a negative slope are shown by data stream 2600 showing current decrease 2431 is detected an instruction 2450 can activate a driver release 2011. In yet another embodiment, an impact detected 2410 condition can communicate data stream 2420 to a positive slope counter and/or data stream 2430 to a negative slope counter.

In a further embodiment, if Np instances of positive slope showing current increase 2041 is detected, then positive slope counter data 2460 can be processed and the controller can determine whether a change in current is within control limits 2461. In a still further embodiment, if Nn instances of negative slope showing current decrease is detected, then negative slope counter data 2470 can be processed and the controller can determine whether a change in current is within control limits 2461. If a change in current is within control limits 2461, then an instruction 2480 can activate a driver release 2011.

A wide variety and broad range of parameters, data types and set point conditions can be used by the driver control system to activate a driver release 2011.

In an embodiment, data stream 2700 is input to a band slope counter 2701. If Nb current change slopes of a change of current are within a set range and/or set band than such data can be used to either active a driver release 2011 or be processed by data stream 2439 as a current change within limits. If the counted number of current change slopes is greater than a set number, Nb>set number, then the driver release 2011 can be activated. If Nb is lower than the set number, Nb<set number, then driver release will not be activated.

In another embodiment, if a current and/or change of current is within a set range and/or set band for a specified duration of time, then the driver release can be activated.

In an embodiment, the change in current which can be a set point for driver release can be an increase in current, motor current, average current, or battery current in a range of from 0.1 amp to 50 amp, 0.5 amp to 10 amp, 1.0 amp to 10 amp, 2.0 amp to 10 amp, 5 amp to 10 amp, 10 amp to 40 amp, 10 amp to 50 amp, or 0.1 amp or greater, or 0.25 amp or greater, or 0.5 amp or greater, or 1.0 amp or greater, or 1.5 amp or greater, or 2.0 amp or greater, or 5 amp or greater, or 10 amp or greater, or 15 amp or greater, or 20 amp or greater, or 25 amp or greater. In an embodiment the change in motor current can be an increase of or 0.1 amp, or 0.2 amp, or 0.25 amp, or 0.5 amp, or 1 amp, or 2 amp, or 3 amp, or 4 amp, or 5 amp, or 6 amp, or 7 amp, or 8 amp, or 9 amp, or 10 amp, or 12 amp, or 15 amp, or 20 amp.

In an embodiment, the change in current which can be a set point for driver release can be a decrease in current, motor current, average current, or battery current in a range of from 0.1 amp to 50 amp, 0.5 amp to 10 amp, 1.0 amp to 10 amp, 2.0 amp to 10 amp, 5 amp to 10 amp, 10 amp to 40 amp, 10 amp to 50 amp, or 0.1 amp or greater, or 0.25 amp or greater, or 0.5 amp or greater, or 1.0 amp or greater, or 1.5 amp or greater, or 2.0 amp or greater, or 5 amp or greater, or 10 amp or greater, or 15 amp or greater, or 20 amp or greater, or 25 amp or greater. In an embodiment the change in motor current can be an increase of or 0.1 amp, or 0.2 amp, or 0.25 amp, or 0.5 amp, or 1 amp, or 2 amp, or 3 amp, or 4 amp, or 5 amp, or 6 amp, or 7 amp, or 8 amp, or 9 amp, or 10 amp, or 12 amp, or 15 amp, or 20 amp.

In an embodiment, the change in current which can be a set point for driver release can current bounded in a range of 20 amp or less, 15 amp or less, 10 amp or less, 5 amp or less, 4 amp or less, 3 amp or less, 2 amp or less, 1 amp or less, or 0.5 amp or less.

In an embodiment, the controller can monitor said driver release condition when driving a fastener, such as a screw, bolt, nut or other fastener.

In an embodiment, the controller can monitor said driver release condition for a plurality of different fasteners.

The controller can monitors a first driver release condition for a first type of fastener and a second driver release condition for a second type of fastener, and the second type of fastener can be different from said first type of fastener.

The controller can monitor monitors a first driver release condition for a first type of screw and a second driver release condition for a second type of screw, and the second type of screw can be different from said first type of screw.

The controller can monitors a first driver release condition for a screw and a second driver release condition for a bolt.

The controller can monitor said driver release condition when loosening and/or removing and/or unscrewing a fastener which is installed in a workpiece.

In an embodiment, the impact driver can have a controller is configured to identify a hammer impact upon a portion an anvil. In an embodiment, the impact driver can have a controller is configured to identify an impact of a portion of a hammer upon a portion an anvil. In an embodiment, the impact driver can have a controller is configured to identify an impact of a lug portion of a hammer upon a portion of an anvil.

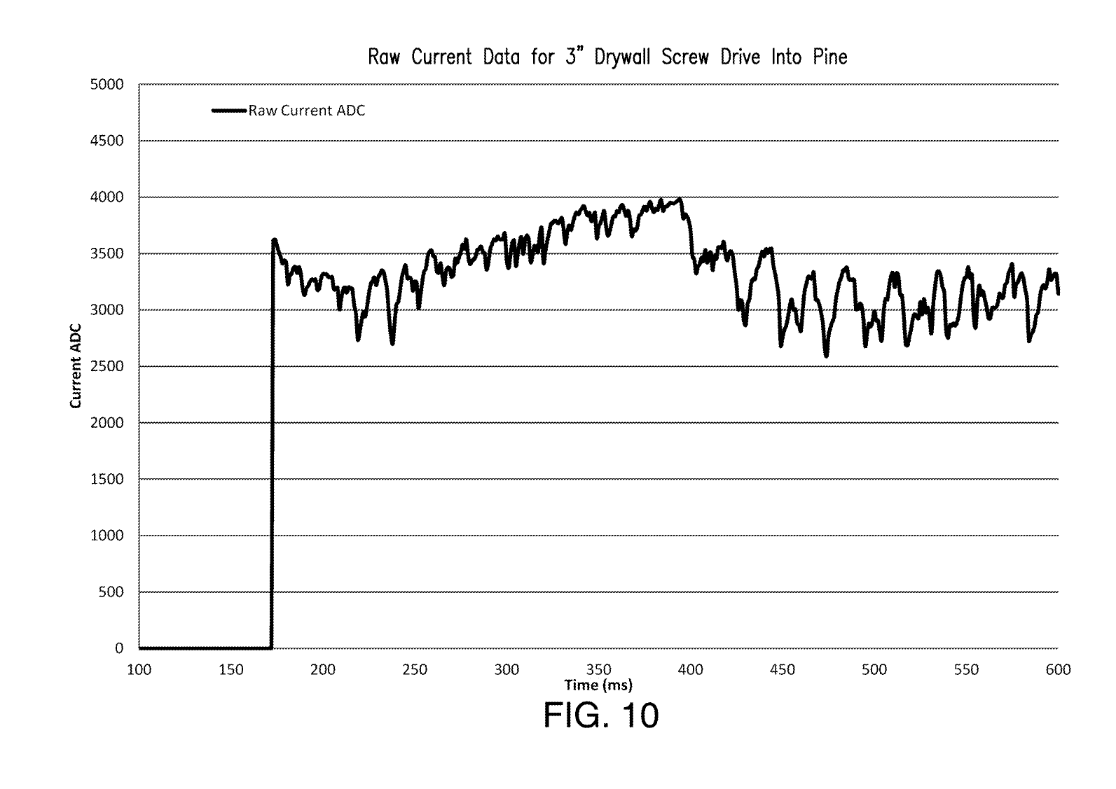

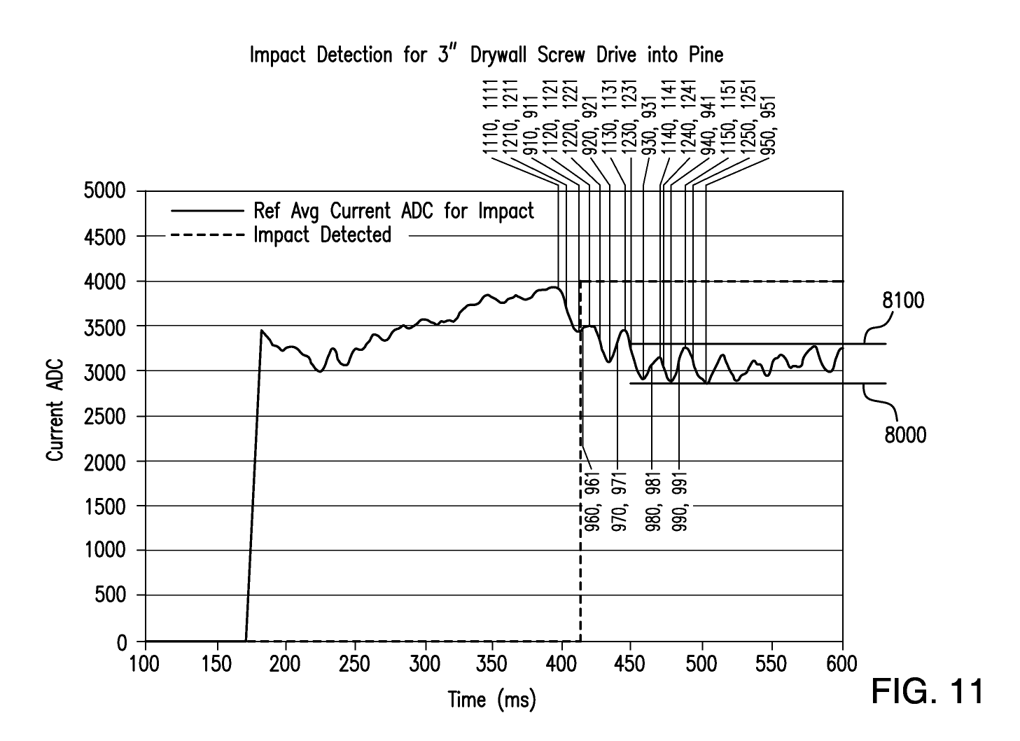

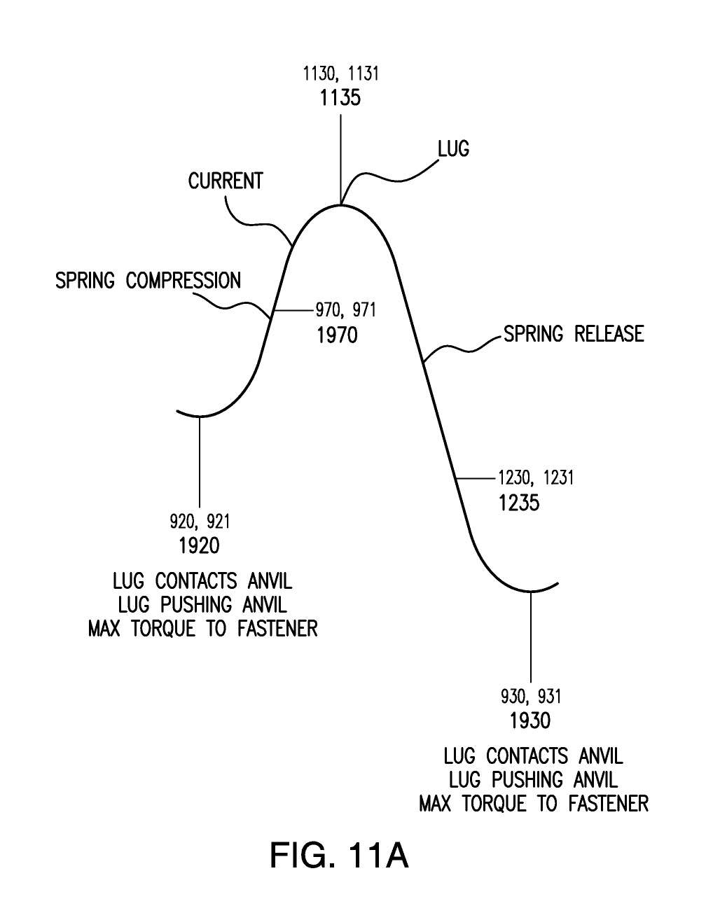

FIG. 10 is a graph of raw current data for an example of an impacting phase during the driving a 3″ drywall screw into a pine workpiece.

FIGS. 10-17 have a vertical axis marked “ADC” which is an analog to digital converter unit. In this application ADC and amp are related by the following equation:

amp=ADC*0.00557=CURRENT ADC*0.00557.

Thus, to convert a current ADC value of 2800 to a value have an ampere unit, the calculation is 2800 ADC*0.00557=15.6 amp.

FIG. 11 is a graph illustrating a reference average current waveform and illustrating impact detection.

FIG. 11 illustrates an impact detection in which the three arrows indicate instances of one or more of the anvil lug 210 resisting one or more of the hammer lug 110 and thus causing the motor current to drop to a low for a given partial rotation of the hammer. For example a hammer lug 110 impact against a resisting anvil lug 210 is indicated by the current minimums indicated in FIG. 11 at times greater than about 380 ms. For example, FIG. 11 shows a first impact 910 at a first current minimum 911, a second impact 920 at a second current minimum 921, a third impact 930 at a third current minimum 931, a fourth impact 940 at a fourth current minimum 941, and a fifth impact 950 at a fifth current minimum 951. Subsequent troughs as time increases represent subsequent impacts.

FIG. 11 also shows when the hammer lug 110 lags the anvil lug 210 and begins to rotate and increase speed and inertia. This period is shown in the increasing motor current which occurs while the hammer rotates. FIG. 11 shows a first lug clearance 960 at a first clearance current increase 961, a second lug clearance 970 at a second clearance current increase 971, a third lug clearance 980 at a third clearance current increase 981, a fourth lag clearance 990 at a fourth clearance current increase 991, and a fifth lug clearance 995 at a fifth clearance current increase 996.

Between impacts, the hammer speeds up before the hammer lug strikes an anvil lug once again. This is reflected in the current data as a local maximum. For example, FIG. 11 shows a first impact speed 1110 at a first impact current 1111, a second impact speed 1120 at a second impact current 1121, a third impact speed 1130 at a third impact current 1131, a fourth impact speed 1140 at a fourth impact current 1141, and a fifth impact speed 1150 at a fifth impact current 1151.

Once a hammer lag 110 meets resistance from or impact up an anvil lag 210, the current drops from the local maximum to a local minimum. This resistance or impact is concomitant with a drop in the speed, torque and inertial of the hammer 100 as energy is transferred to the anvil 200 and the current drops to a local minimum. For example, FIG. 11 shows a first hammer stop 1210 with a first current drop 1211, a second hammer stop 1220 with a second current drop 1221, a third hammer stop 1230 with a third current drop 1231, a fourth hammer stop 1240 with a fourth current drop 1241, and a fifth hammer stop 1250 with a fifth current drop 1251.

The impact driver control system can determine how many impacts have occurred and based upon a release parameter can release the drive system from continuing to apply torque to the anvil via the hammer. An example of release parameters include, but are not limited to: the number of impacts which have occurred, the time which has elapsed after the first impact has occurred, and the change in current fluctuation over a period after which impacting has occurred.

The contact of a portion of a hammer to a portion of an anvil during a non-impacting phase constitutes non-impact driving. Herein, an impact is a striking contact between a hammer and an anvil from the onset of the impacting phase to the conclusion of the impacting phase.

In an embodiment, the parameter which the driver control system can monitor can be the number of impacts which have occurred, such as between a hammer and an anvil. In another embodiment, the parameter which the driver control system can monitor can be can be to count how many impact events have occurred and activate a driver release when the count is higher than a set point, such as in a range of from 1 to 10000 impacts, such as 3 impacts or greater, or 4 impacts or greater, 7 impacts or greater, 8 impacts or greater, 10 impacts or greater, 15 impacts or greater, 20 impacts or greater, 25 impacts or greater, 30 impacts or greater, 35 impacts or greater, 40 impacts or greater, 50 impacts or greater, 100 impacts or greater, 500 impacts or greater, 1000 impacts or greater. In an embodiment, an impact is counted by one hammer lug 110 striking one anvil lug 210. In another embodiment, multiple lugs hitting can be an impact. The driver control system is highly flexible regarding how impacts are counted or monitored.

In an embodiment, the parameter which the driver control system can monitor can be time during which an impacting phase exists, such as the time during which the hammer 100 is impacting upon the anvil 200. In an embodiment, the length of an impacting phase can be measured as the time which has elapsed after the first impact has occurred. In another embodiment, the length of an impacting phase can be measured as the time which has elapsed after a given number of impacts have occurred. In an embodiment, the driver control system can activate a driver release in a range of from 1 ms to 10000 ms after an impact, such as a after the first impact of an impacting phase, such as in a range of from 1 ms to 100 ms, or 1 ms to 100 ms, or 50 ms to 150 ms, or 50 ms to 200 ms, or 100 ms to 300 ms, or 100 ms to 500 ms, or 250 ms to 500 ms, or 250 ms to 750 ms, or 300 ms to 1000 ms, or 100 ms to 2000 ms, or 500 ms to 2000 ms, or 1000 ms to 3000 ms, or 100 ms or greater, or 200 ms or greater, or 300 ms or greater, or 400 ms or greater, or 500 ms or greater, or 750 ms or greater, or 1000 ms or greater, or 1500 ms or greater, or 2000 ms or greater, or 2500 ms or greater, or 3000 ms or greater.

In an embodiment, the parameter which the driver control system can monitor can be the magnitude of change to a current over a period of time during which an impacting phase exists, such as the time during which the hammer 100 is impacting upon the anvil 200. In an embodiment, the driver control system can activate a driver release when the magnitude of the change of current is 11.14 amp (2000 ADC) or less per impact event, or 9.75 amp (1750 ADC) or less per impact event, 8.55 amp (1500 ADC) or less per impact event, 6.96 amp (1250 ADC) or less per impact event, 5.57 amp (1000 ADC) or less per impact event, 4.17 amp (750 ADC) or less per impact event, 2.78 amp (500 ADC) or less per impact event, 1.39 amp (250 ADC) or less per impact event, 1.14 amp (200 ADC) or less per impact event, 0.836 amp (150 ADC) or less per impact event, 0.557 amp (100 ADC) or less per impact event, 0.28 amp (50 ADC) or less per impact event, 0.14 amp (25 ADC) or less per impact event, 0.056 amp (10 ADC) or less per impact event. In an embodiment, an impact event can have a current change associated with the period from the clearance phase 1135, spring release phase 1235 and the impact phase 1930 as shown in FIG. 11A an which can be measured against upper and lower limits and/or a change in current by the driver control system as a parameter which when satisfied can be used to activate a driver release. In another embodiment, the impact event can have a current change associated with the period from impact phase 1920, to compression phase 1970, to clearance phase 1135, through release phase 1235 and to impact phase 1930.

In an embodiment, if a change of current per impact event is less than a set change in current over a period of time the driver control system can activate a driver release. In an embodiment, if a change of current per impact event is less than a set value over a number of impact events the driver control system can activate a driver release. In an embodiment, if a change of current per impact event is less than a set value over a number of impact events and a period of time the driver control system can activate a driver release.

FIG. 11 also shows a lower current boundary 8000 and an upper current boundary 8100. In an embodiment, a change in current, or change in current over time, or current fluctuation, or current fluctuation over time can be a parameter used by the impact diver control to activate driver release. In another embodiment, a current change or fluctuation of a current within a range between the lower current boundary 8000 and the upper current boundary 8100 can be a parameter used by the impact diver control to activate driver release. The change in current can be measured and used as a parameter to activate driver release on a basis of impacts, cycles of current fluctuation, value of current change, slope of current change, or a count of the number of current changes which are with the range between the lower current boundary 8000 and the upper current boundary 8100. In the example of FIG. 11 a change in current within the lower current boundary 8000 of 15.6 amp (2800 ADC) and the upper current boundary 8100 of 18.6 amp (3350 ADC) can be used by the impact driver control system to active a driver release. In another embodiment, 1 . . . n cycles of current fluctuation between the lower current boundary 8000 of 15.6 amp (2800 ADC) and the upper current boundary 8100 of 18.6 amp (3350 ADC) can be used by the impact driver control system to active a driver release. In another embodiment, current fluctuation between the lower current boundary 8000 of 15.6 amp (2800 ADC) amp and the upper current boundary 8100 of 18.6 amp (3350 ADC) which occurs for a time greater than a set time, such as 50 ms or greater, or 75 ms or greater, or 100 ms or greater, or 125 ms or greater, or 200 ms or greater, can be used by the impact driver control system to active a driver release.

FIG. 11A shows a current waveform annotated for a hammer lug impact cycle upon an anvil during an impacting event. FIG. 11A is a break out of the impact cycle shown in FIG. 11 of the second impact 920 at a second current minimum 921 through the third impact 930 at a third current minimum 931. In this example, five (5) phases of an impact event are identified: (1) second lug 210 impact phase 1920; (2) impact spring 300 compression phase 1970; (3) second lug 210 clearance phase 1135; (4) impact spring 300 release phase 1235; and (5) third hammer lug 130 impact phase 1930.

During the second lug 210 impact phase 1920, the second hammer lug 120 is impacting upon the first anvil lug 211 in a second impact of a series of sequential impacts of a number of the hammer lug 110 upon the first anvil lug 211. When the second hammer lug 120 is impacting upon the first anvil lug 211 the hammer imparts a force, such as a torque, to the first anvil lug 211. In this circumstance, the first anvil lug 211 resists rotation and/or movement and the speed of rotation of the hammer 100 is at a local minimum and/or stopped. When the speed of rotation of the hammer 100 is at a local minimum and/or stopped, the motor current call also decrease to a local minimum which is shown as the second current minimum 921 of FIG. 11. When the motion of the hammer 100 is at a local minimum, the torque imparted to the anvil 200 is also at a local minimum. The resistance of the first anvil lug 211 to rotation and/or movement begins the spring compression phase 1970.

During the impact spring 300 compression phase 1970, the impact spring 300 begins to compress and the hammer 100 begins to both retract away from anvil 200 along output spindle centerline 1000 and to increase the rotational motion of the hammer 100. During the spring compression phase 1970, the current increases as the impact spring 300 compresses and the hammer 200 moves. Hammer lug clearance occurs when the lug has retracted enough to clear the anvil lug against which it is acting. In this example, lug clearance occurs when the second hammer lug 120 retracts sufficiently to clear the first anvil lug 211, thus reaching the anvil clearance phase 1135. It is at the moment instantly before the second hammer lug 120 clears the first anvil lug 211 that its potential is highest.

During the second lug 210 clearance phase 1135, the second hammer lug 120 clears the first anvil lug 211 and the hammer rapidly rotates.

During the impact spring 300 release phase 1235, the hammer continues to rapidly rotate and the impact spring pushes the hammer toward the anvil. This action, engages the third hammer lug 130 in the space between the first anvil lug 211 and the second anvil lug 221, similar to the teeth of gearing fitting together (FIG. 5F). This phase ends when the third hammer lug 130 impacts upon the second anvil lug 221. At the moment of impact of the third hammer lug 130 impacts upon the second anvil lug 221 the impact force and/or impact torque is at its local maximum. From the moment of this impact, the rotation of the hammer 100, the speed of the motor 20 and the current again are forced to another local minimum.

During the third hammer lug 130 impact phase 1930. The process of spring compression and lug clearance repeats, as shown by the waveform of FIG. 11.

There is no limit to the number of hammer lugs 110 which the hammer 100 can use, or the number of anvil lugs 210 that the anvil 200 can use. Further, when multiple lugs are used the current waveform can change in amplitude and/or frequency. However, the physics of the impact event as regards current and force local maximums and minimums will remain consistent and can be used by the impact driver control system to control when a driver release is activated.

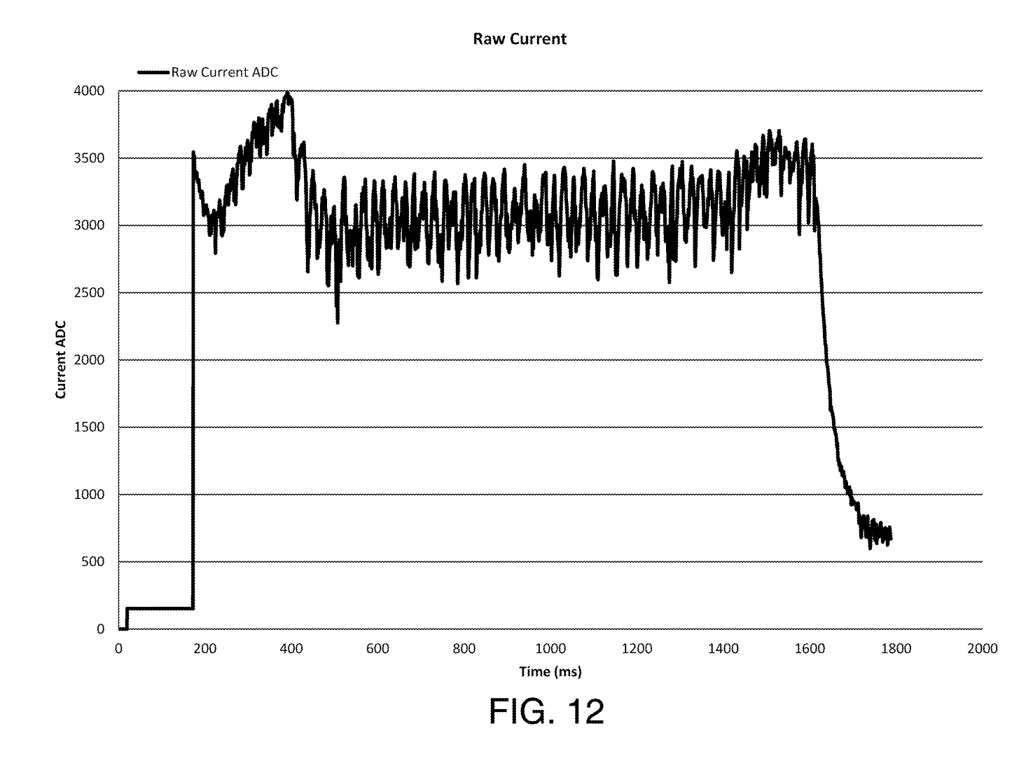

FIG. 12 is an example of a raw current waveform during an impacting drive of a fastener.

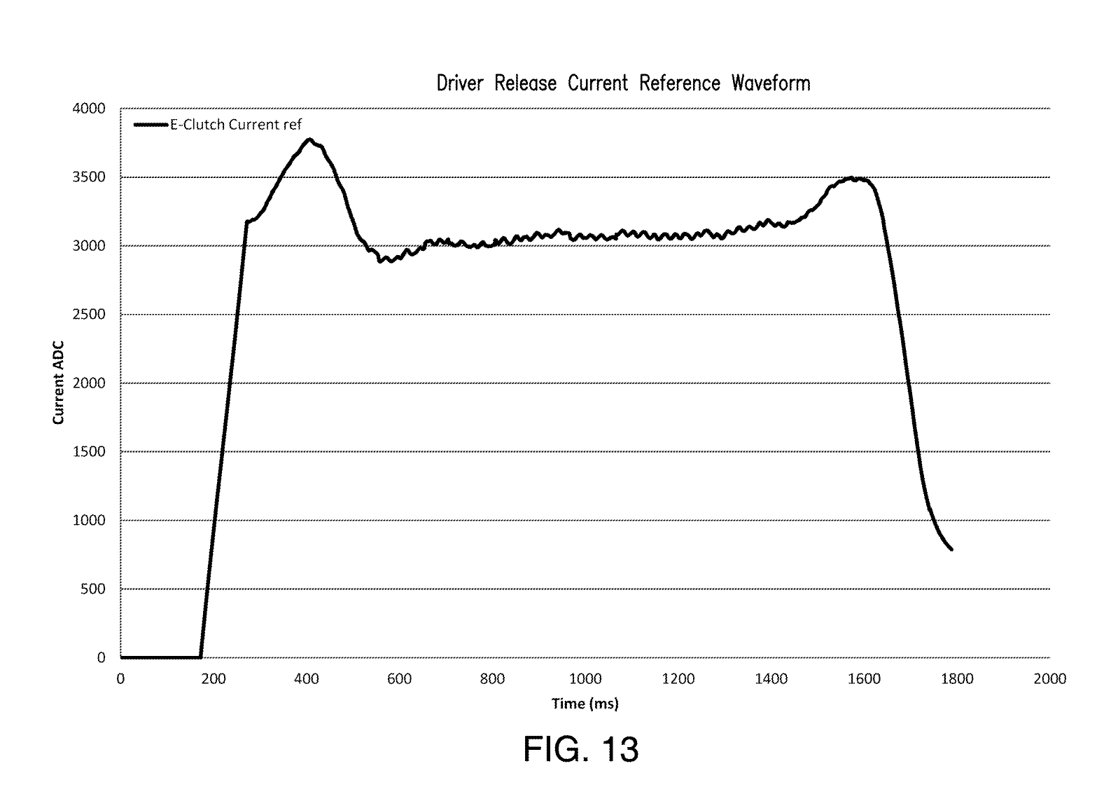

FIG. 13 is an example of an eclutch (also herein as “driver release”) reference waveform during an impacting drive of a fastener.

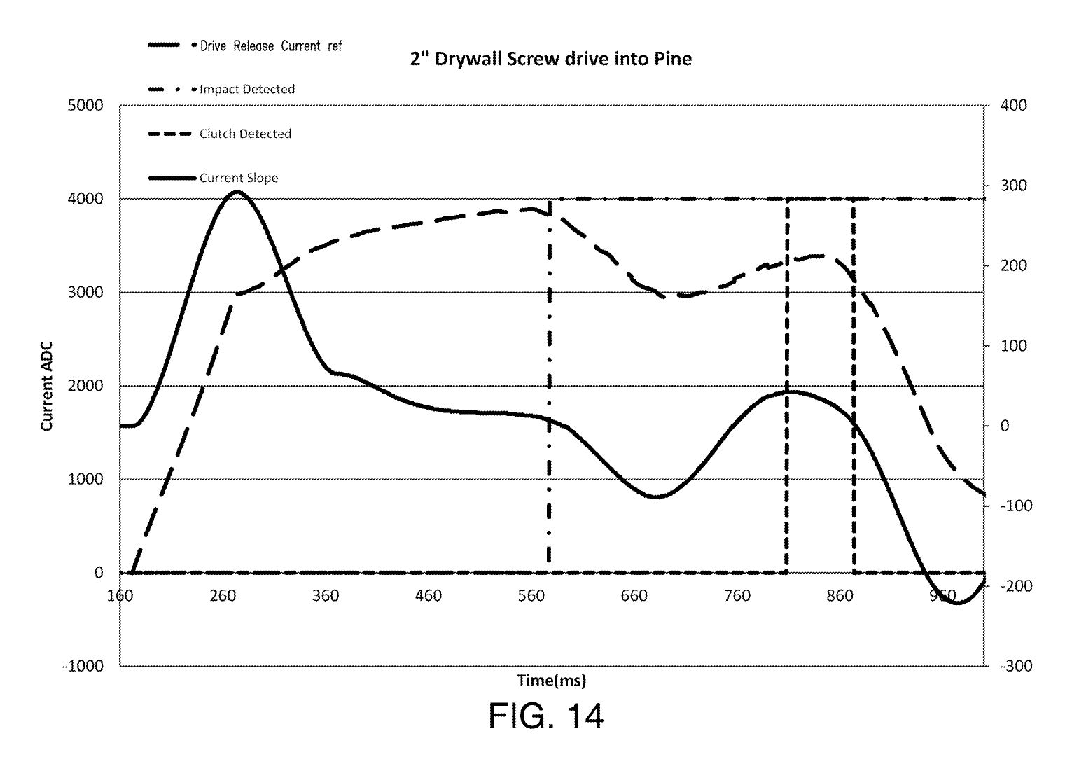

FIG. 14 is a graph illustrating a driver control analysis for driving a 2″ drywall screw into a pine workpiece with an impact driver.

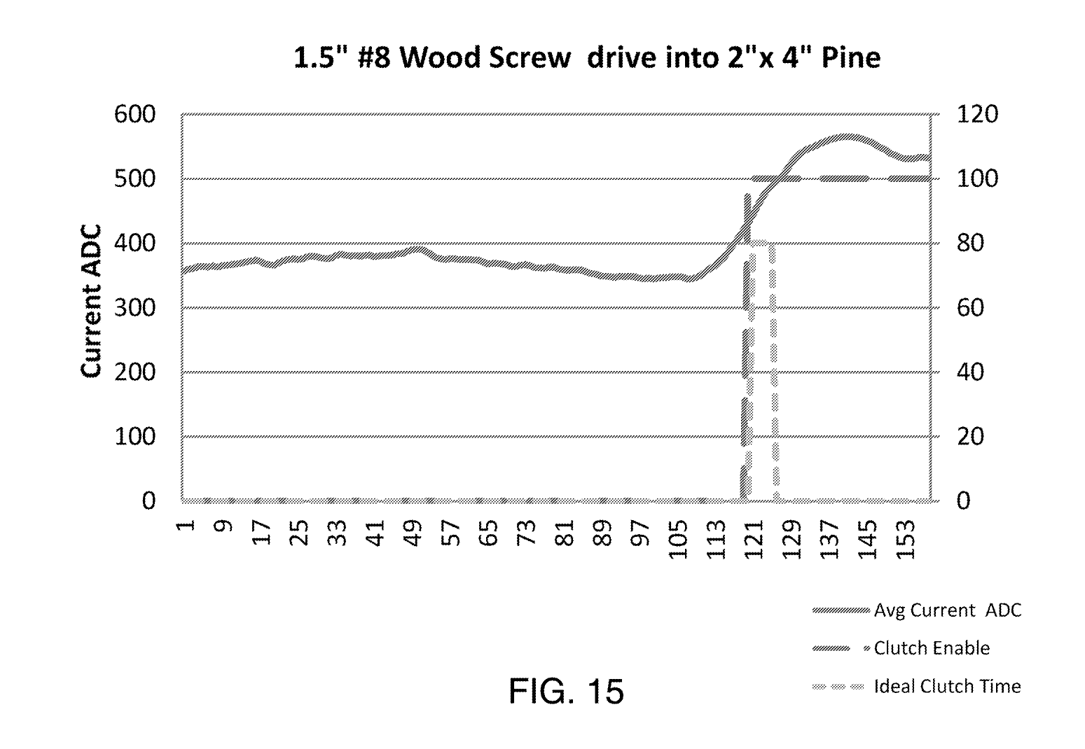

FIG. 15 is a graph illustrating a driver control analysis for driving a 1.5″ #8 drywall screw into a 2″×4″ pine workpiece with an impact driver.

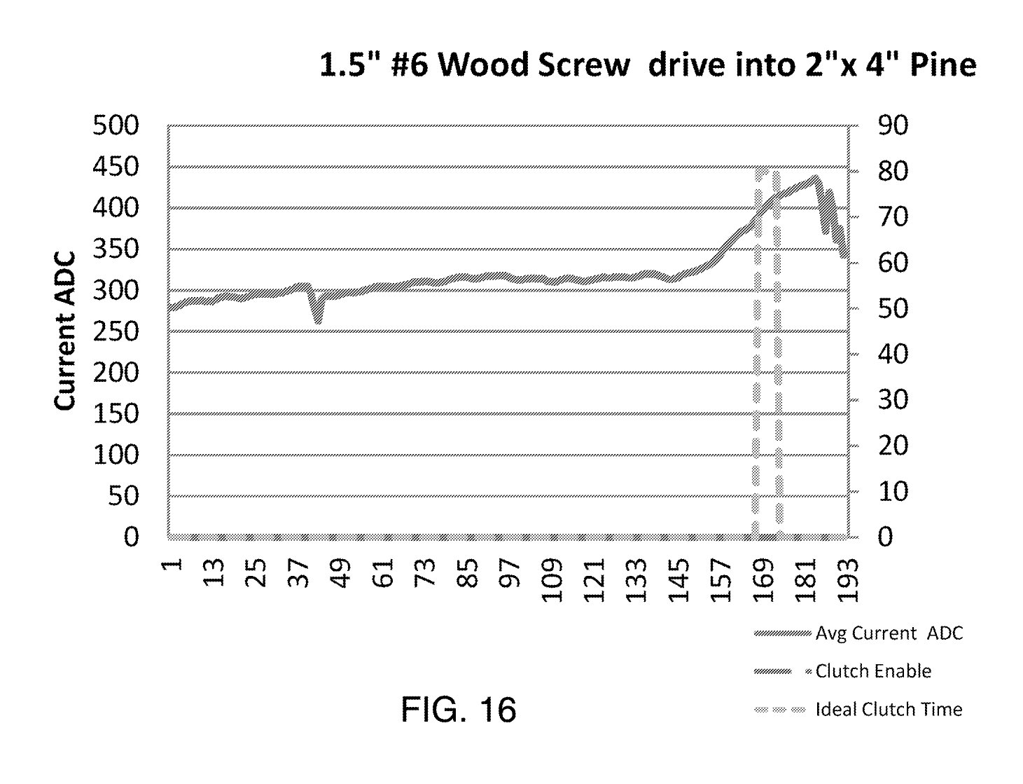

FIG. 16 is a graph illustrating a driver control analysis for driving a 1.5″ #6 drywall screw into a 2″×4″ pine workpiece with an impact driver.

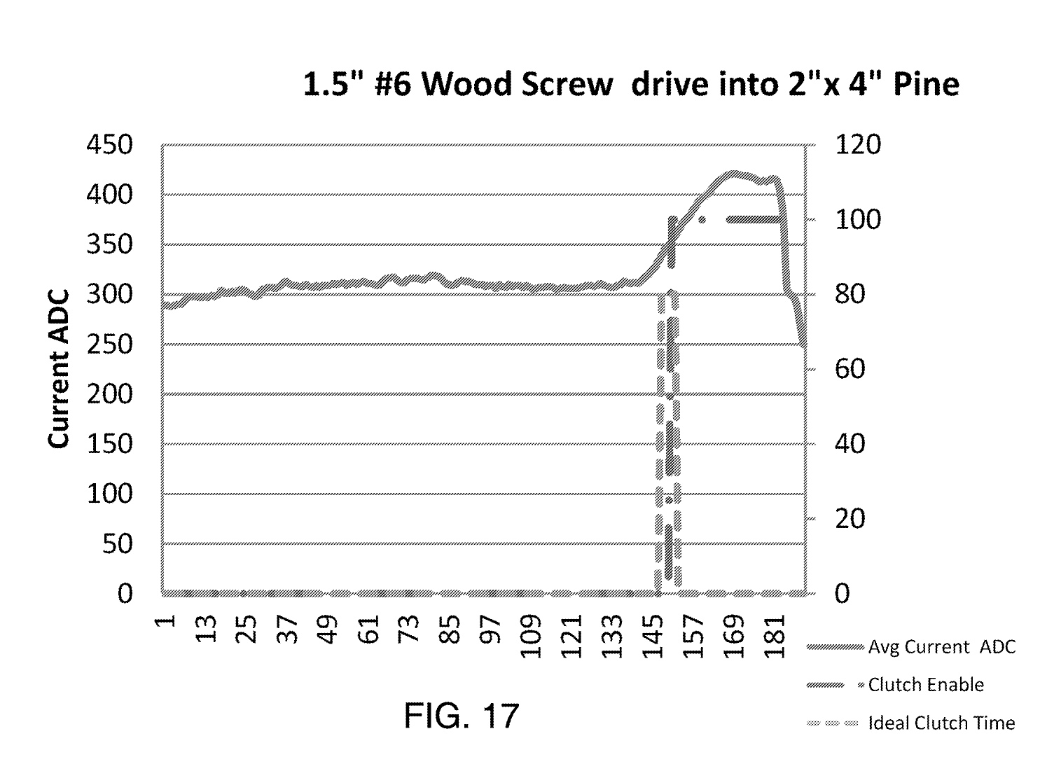

FIG. 17 is a graph illustrating a driver control analysis for driving a 1.5″ #6 wood screw into a 2″×4″ pine workpiece with an impact driver.

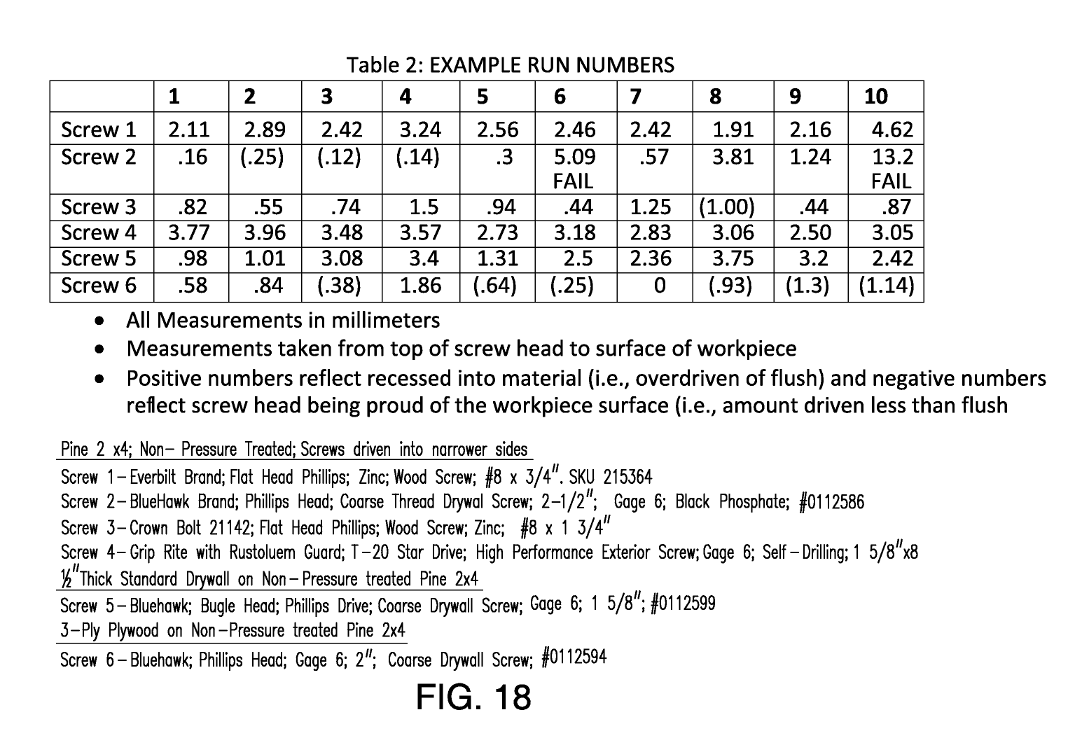

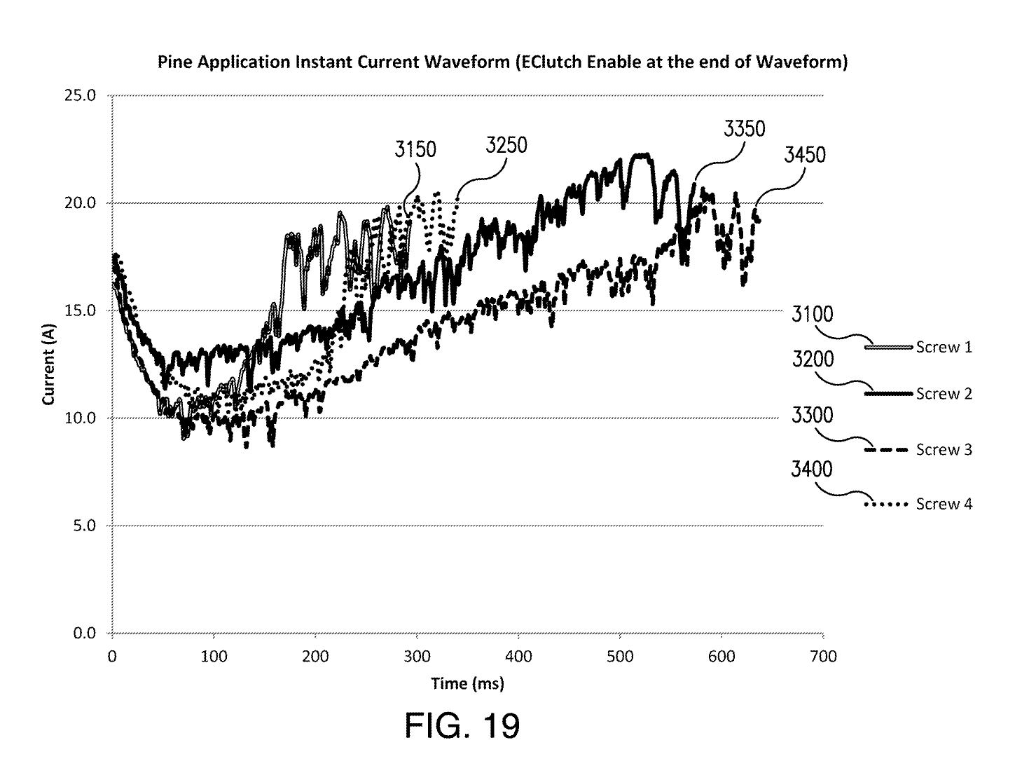

FIG. 18 provides a Table 2 listing the example screws and related data for the examples illustrated in FIGS. 19-27.

FIG. 19 is a graph showing motor current waveforms for four (4) different types of screws being driven by an impact driver.

FIG. 19 is an example which compares the impact driving of four (4) different screws into a non-pressure treated pine 2″×4″ workpiece. The four (4) different types of screws are as follows: (Example 1) Screw 1 which is an Everbilt Brand having a flat head Phillips which is a zinc, wood screw, #8×¾″ with SKU 215364; (Example 2) Screw 2 which is an BlueHawk Brand having a Phillips head which is a coarse thread drywall screw, 2½″, gage 6; black phosphate; #0112586; (Example 3) Screw 3 which is an Crown Bolt 21142 having a flat head Phillips which is a zinc, wood screw, #8×1¾″; (Example 4) Screw 4 which is an Grip Rite with Rustoluem guard having a T-20 star drive which is a high performance exterior screw; Gage 6; Self-Drilling, 1⅝″×8.

The impact drive of Screw 1 is shown by line 3100 which terminates at an impact release current 3150. In this example impact release current 3150 is 18.5 amp. The impact drive of Screw 2 is shown by line 3200 which terminates at an impact release current 3250. In this example impact release current 3150 is 20 amp. The impact drive of Screw 3 is shown by line 3300 which terminates at an impact release current 3350. In this example impact release current 3150 is 21 amp. The impact drive of Screw 4 is shown by line 3400 which terminates at an impact release current 3450. In this example impact release current 3150 is 19 amp.

There is not limitation as to the value of the impact release current. The impact release current for different nails can be the same or different. The impact release current for the same nail type in different workpiece type can be the same or different. The impact release current for different nail types in different workpiece type can be the same or different. The impact release current for different nail types in the same workpiece type can be the same or different. In some circumstances, the impact release current for the same nail type in the same workpiece type can be different. In some circumstances, the impact release current for the same nail type in the same workpiece type can be the same.

The impact driver control system can activate a driver release an impact release current which matches parameters or set points for type of fastener, type of workpiece, condition of the impact driver, current, torque, motor speed or other parameter. Many different impact release current set points and/or values can be used by the impact driver control system.

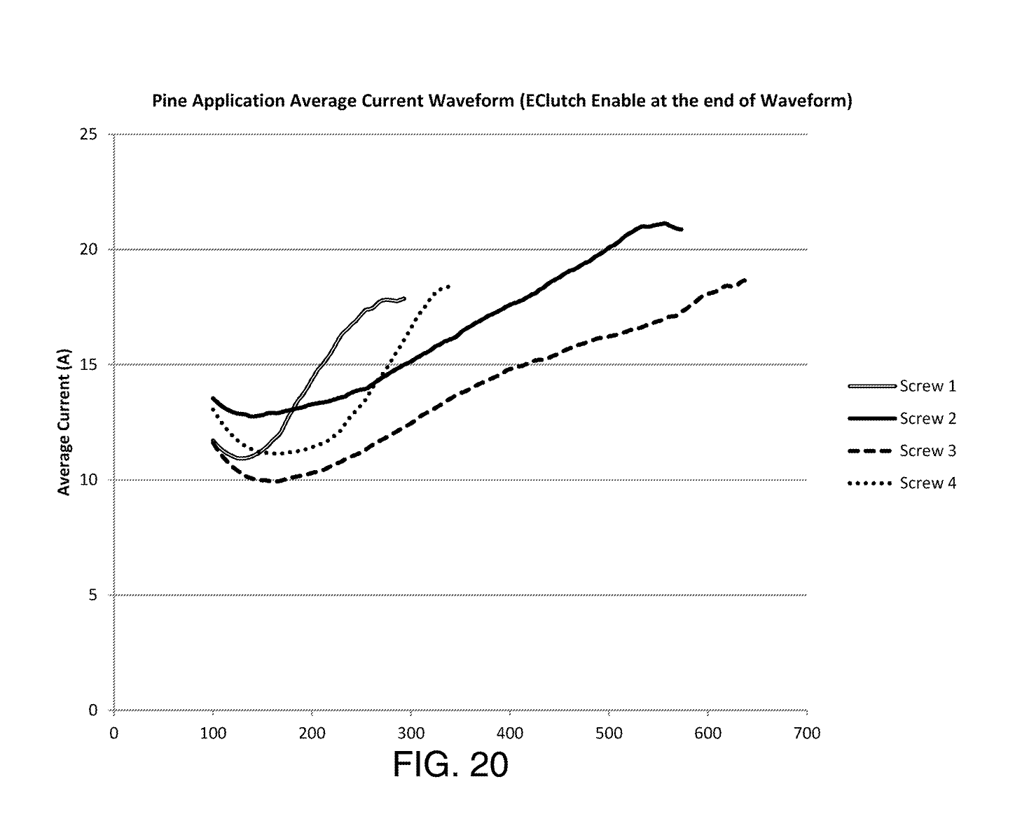

FIG. 20 is a graph showing average current waveforms for four (4) different types of screws of the example of FIG. 19 being driven by an impact driver.

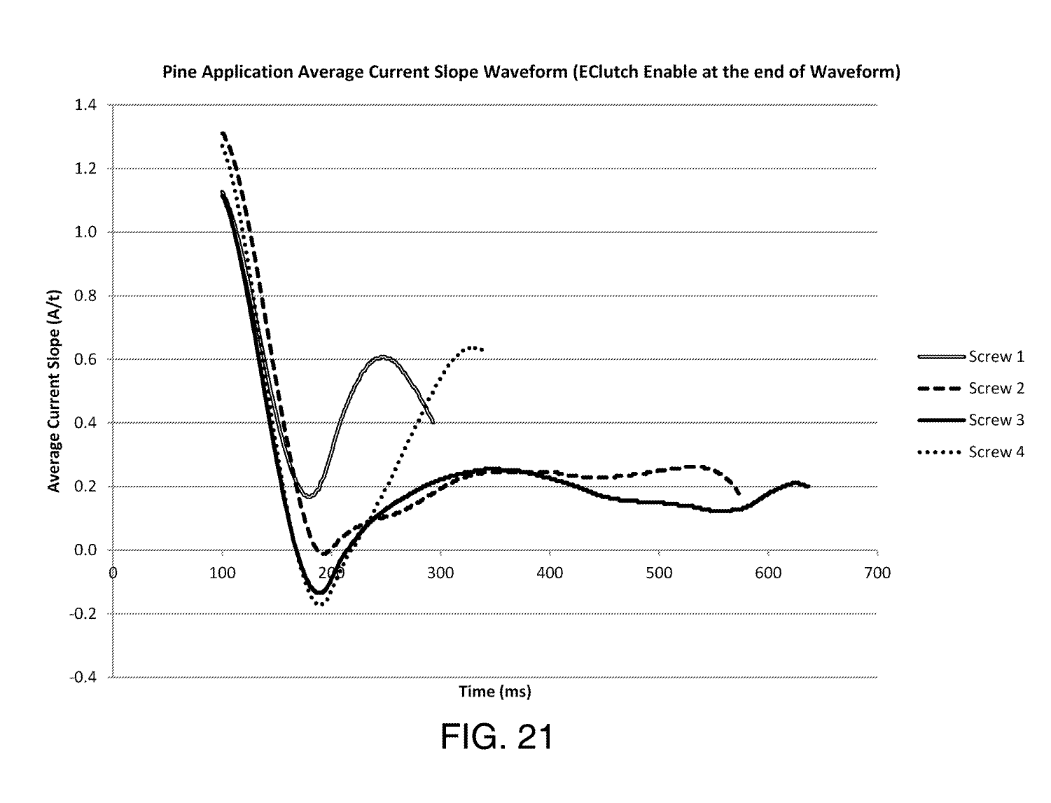

FIG. 21 is a graph showing average current slope waveforms for four (4) different types of screws of the example of FIG. 19 being driven by an impact driver.

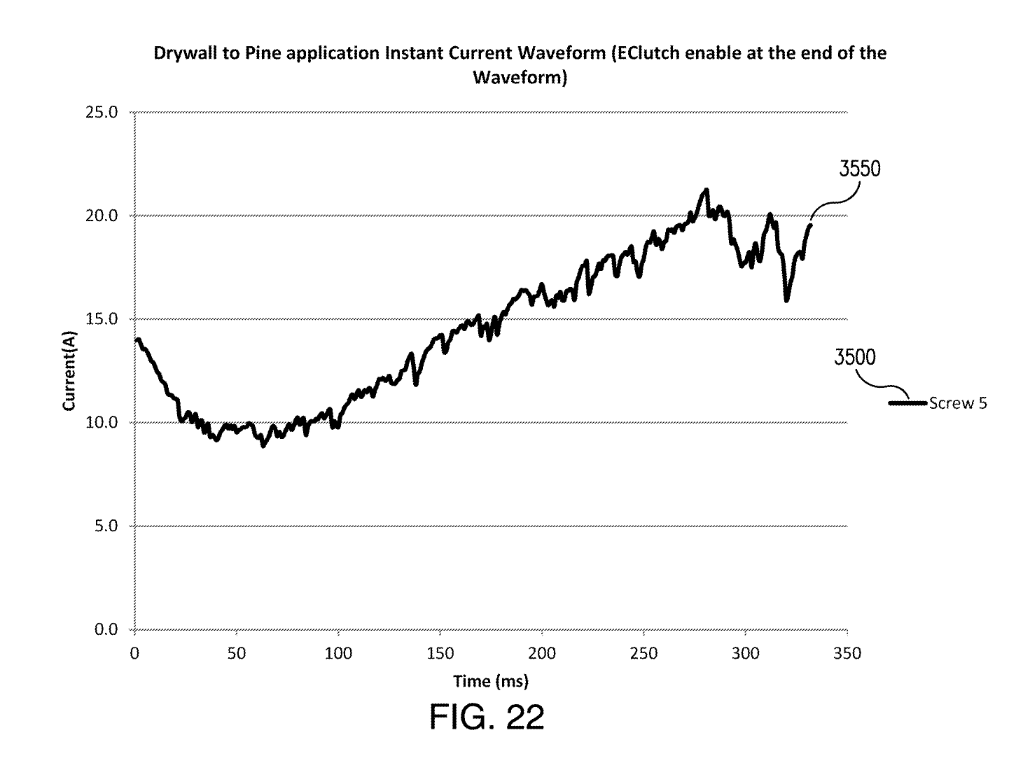

FIG. 22 is a graph showing a current waveform for a screw being driven into a pine workpiece and having a release current. FIG. 22 is an example of the impact driving of a Screw 5 driven through ½″ thick standard drywall on a non-pressure treated pine 2″×4″. The screw penetrates and is driven through the drywall and into the pine 2″×4″. The (Example 5) Screw 5 is a Bluehawk having a bugle head and Phillips drive; Coarse Drywall Screw of gage 6, with a 1⅝″ length and SKU #0112599.

The waveform for the current of this example is shown as line 3500 having impact release current 3550.

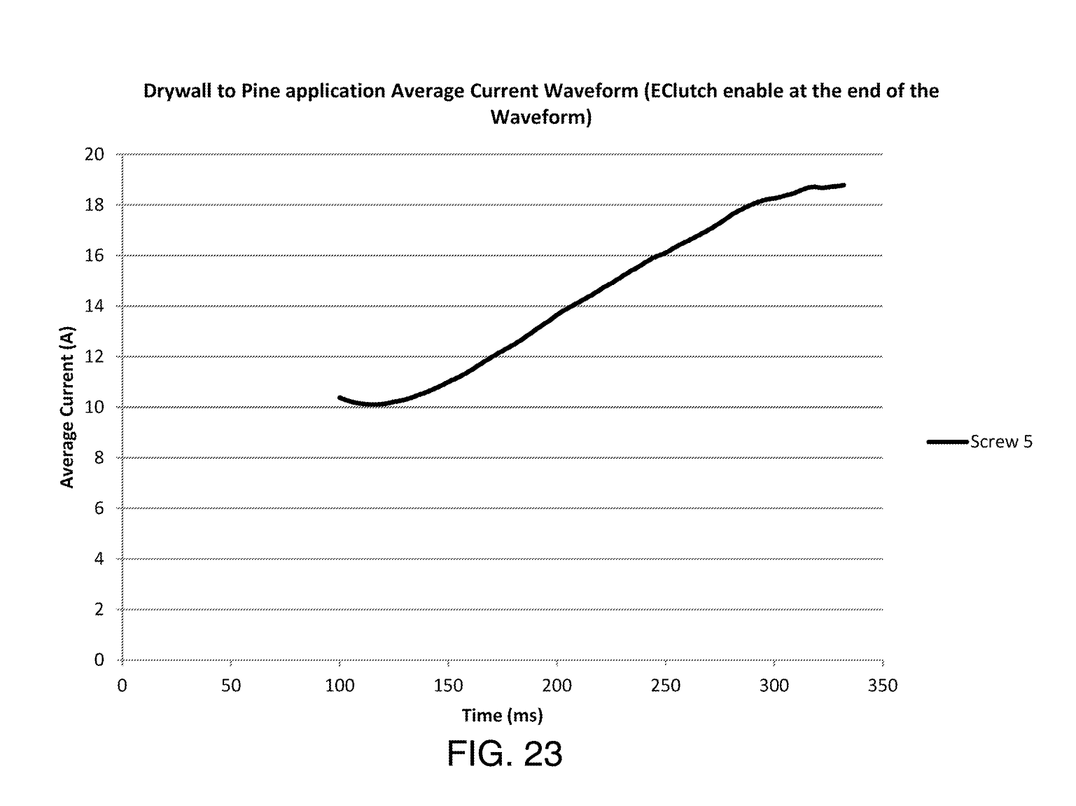

FIG. 23 is a graph showing an average current waveform for Screw 5 of the example of FIG. 22 being driven into a pine workpiece.

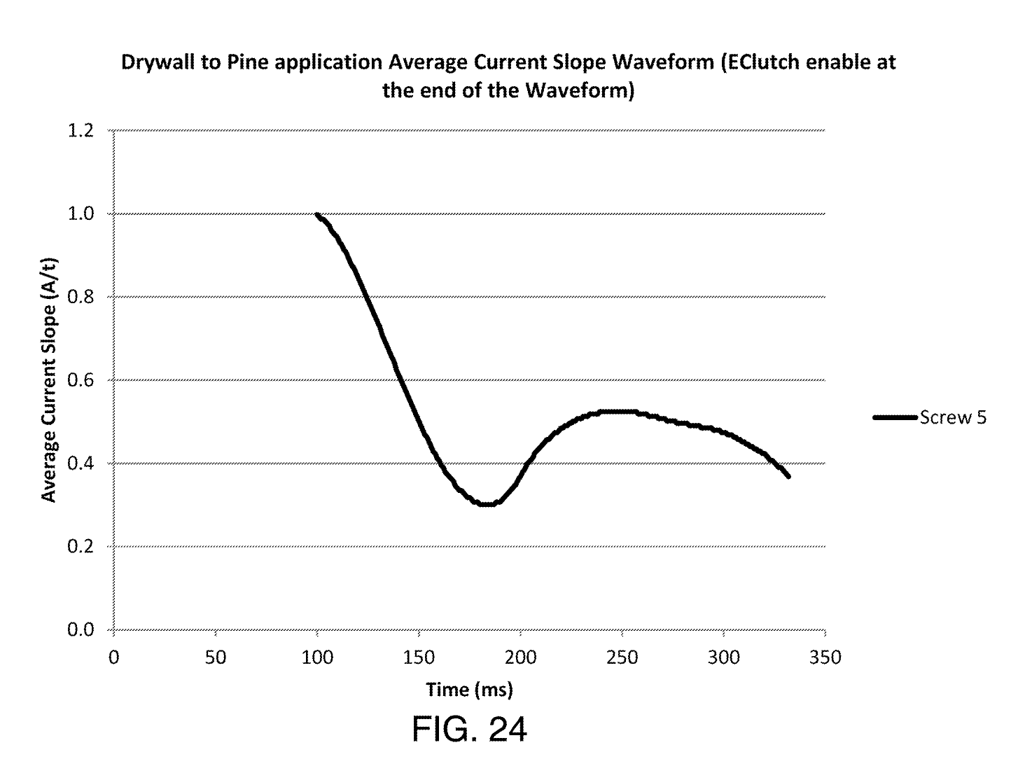

FIG. 24 is a graph showing an average current slope waveform for a Screw 5 of the example of FIG. 22 being driven into a pine workpiece.

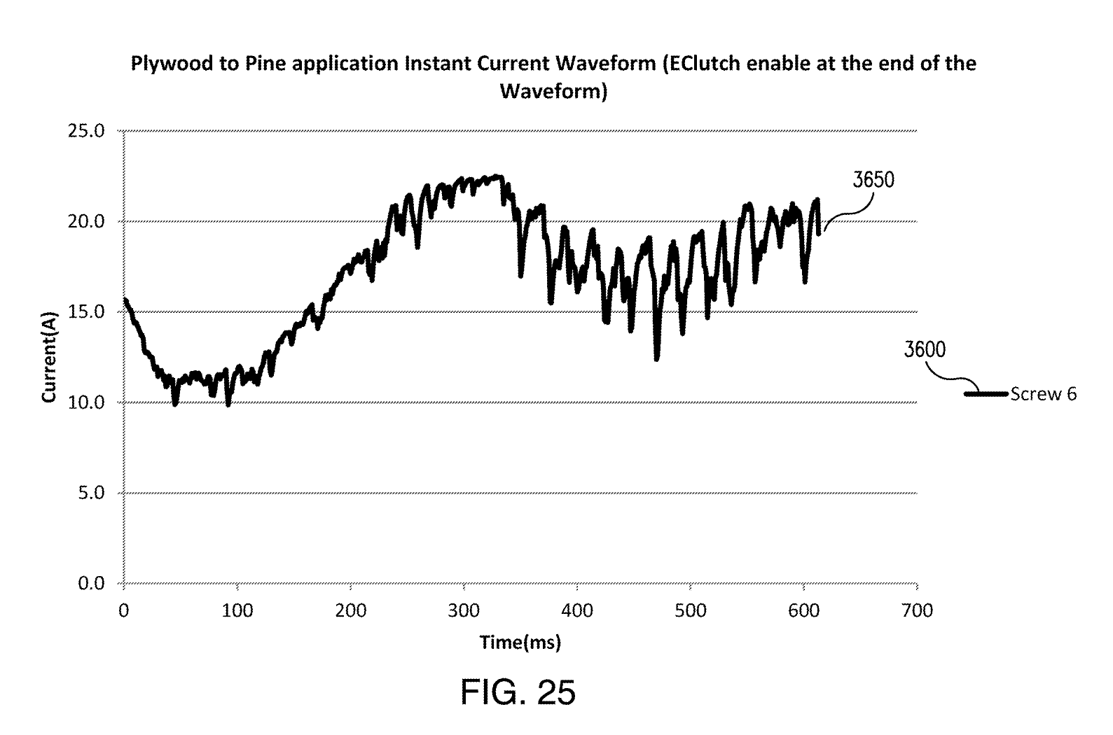

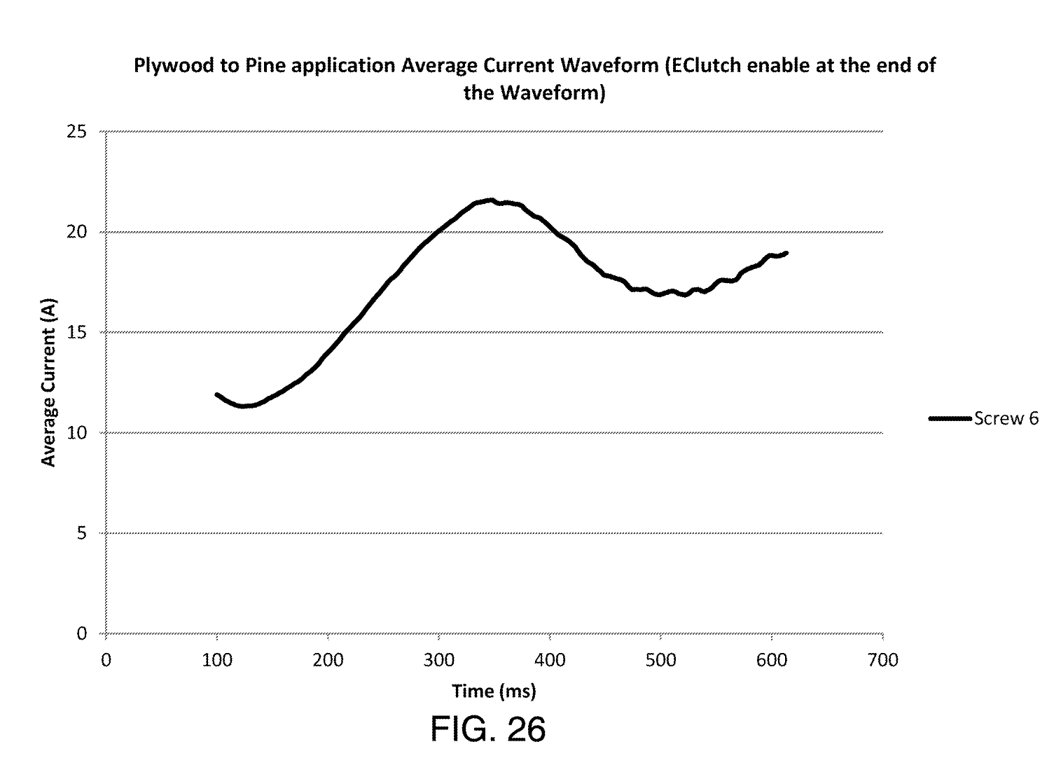

FIG. 25 is a graph showing a current waveform for a screw being driven into a plywood to pine workpiece and having a release current. FIG. 26 is an example of the impact driving of a Screw 6 into a 3-ply plywood on non-pressure treated pine 2″×4″. The screw penetrates and is driven through the plywood and into the pine 2″×4″. The (Example 6) Screw 6 is a Bluehawk having a Phillips head of Gage 6 and a 2″ length, coarse drywall Screw with a SKU #0112594.

The waveform for the current of this example is shown as line 3600 having impact release current 3650.

FIG. 26 is a graph showing an average current waveform for a Screw 6 of the example of FIG. 25 being driven into a plywood to pine workpiece.

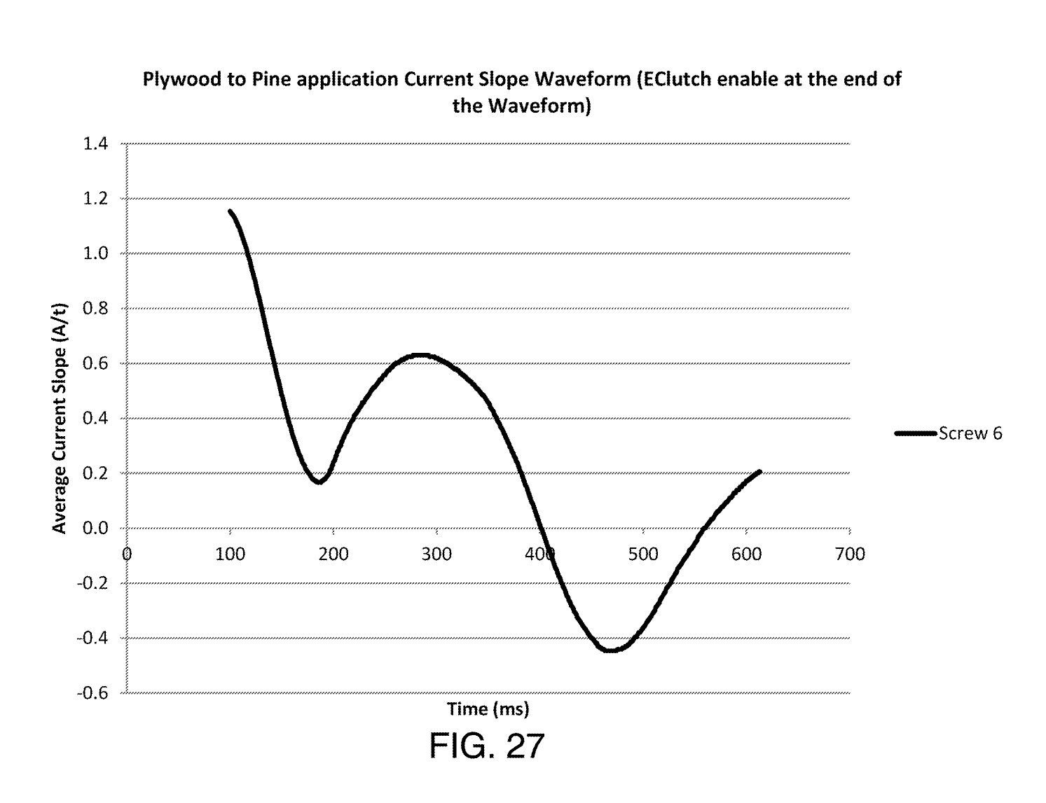

FIG. 27 is a graph showing an average current slope waveform for a Screw 6 of the example of FIG. 25 being driven into a pine workpiece.

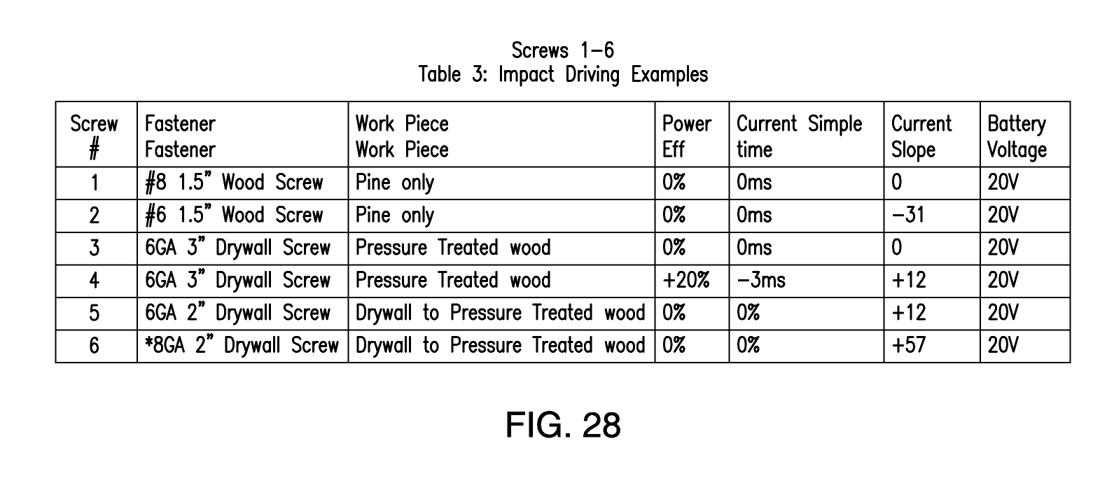

FIG. 28 is a table providing current slope and battery voltage for a variety of fasteners driven into a variety of workpieces.

In an embodiment of an impact diver, a parameter setting can be chosen to use one or more of a variety of parameters. The selection of a parameter can be an electronic mode selection or can be made by a mechanical switch or other means. The parameter to use to activate a driver release can be chosen by the operator or otherwise selected as a mode. Such a parameter can be in non-limiting example: motor speed, current sampling time, current, motor current, torque or other parameter.

In an embodiment, a threshold or set point at which a driver release is activated can be adjustable by user or predefined in the control system based on a type of fastener application, fastener and/or workpiece. For example, in a 1.5″ #8 wood screw drives into a pine wood application, the maximum motor speed can have a limit to 80%, positive slope threshold which can be be 0.278 amp/t (ADC value=50) and current sampling time can be 4 ms. In another example, a 6 GA 3″ drywall screw can be driven into Pressure treaded wood, and the maximum motor speed can be a 100%, positive slope with a threshold which can be 0.346 amp/t (ADC value=62) and have a current sampling time is 1 ms. In yet another example, a 1.5″ #8 wood screw (FIG. 28 Screw 1) can be driven into pine wood application can be defined as a standard setting. FIG. 28 shows different application parameters settings as compare to that of a standard setting. In FIG. 28 “Power Eff” correlates to a change in motor speed. For example, if “Power Eff” is 0% the motor speed is the same as the motor speed of the standard of the drive of Screw 1 over the course of the drive of a given screw. For example, if “Power Eff” is +20%, Screw 4, Table 3, the motor speed increased 20% over the standard of the drive of Screw 1 over the course of the drive of Screw 4.

This scope disclosure is to be broadly construed. It is intended that this disclosure disclose equivalents, means, systems and methods to achieve the devices, activities and mechanical actions disclosed herein. For each process, control system, electronic hardware or software feature, mechanical element or mechanism disclosed, it is intended that this disclosure also encompass in its disclosure and teaches equivalents, means, systems and methods for practicing the many aspects, mechanisms and devices disclosed herein. Additionally, this disclosure regards a power tool such as an impact driver and its many aspects, features and elements. Such a fastening tool can be dynamic in its use an operation, this disclosure is intended to encompass the equivalents, means, systems and methods of the use of the tool and its many aspects consistent with the description and spirit of the operations and functions disclosed herein. The claims of this application are likewise to be broadly construed.

The description of the inventions herein in their many embodiments is merely exemplary in nature and, thus, variations that do not depart from the gist of the invention are intended to be within the scope of the invention. Such variations are not to be regarded as a departure from the spirit and scope of the invention.

We claim:

1. An impact driver, comprising:
a motor which provides a driving force to an impact mechanism;
a controller which is an electronic controller and which controls the state of a driver control system;
the controller monitoring a parameter of the impact driver;
the controller configured to activate the driver control system to free the impact mechanism from the driving force when the parameter satisfies a driver release condition; and
wherein a release activation value of the parameter which satisfies the driver release condition varies depending upon at least one of a driving condition.

2. The impact driver according to claim 1, wherein the parameter is at least one of a current, an rpm of a motor and a torque.

3. The impact driver according to claim 1, wherein the release activation value varies depending upon a type fastener being driven.

4. The impact driver according to claim 1, wherein the release activation value varies depending upon a type of workpiece into which a fastener is being driven.

5. The impact driver according to claim 1, wherein the parameter is a motor current; and
the driver release condition comprises a first decrease of the motor current over a first time period, followed by a first increase in motor current over a second time period, followed by a second decrease of the motor current over a third time period, followed by a second increase in in motor current over a fourth time period.

6. The impact driver according to claim 1, wherein the parameter is a motor current and the driver release condition comprises an increase in the motor current over each of a number of sequential sampling periods.

7. The impact driver according to claim 1, wherein the parameter is a motor current and the driver release condition comprises an increase in the motor current to a value greater than an upper limit of motor current.

8. The impact driver according to claim 1, wherein the parameter is a motor current and the driver release condition comprises a decrease in the motor current over each of a number of sequential sampling periods.

9. The impact driver according to claim 1, wherein the parameter is a motor current and the driver release condition comprises a decrease in a the motor current to a value lower than a lower limit of motor current.

10. The impact driver according to claim 1, wherein the parameter is a motor current and the driver release condition comprises a change in the motor current, wherein the change in current is less than a current change limit over a number of sampling periods.

11. The impact driver according to claim 1, wherein the parameter is a motor current and the driver release condition comprises a change in the motor current, wherein the motor current remains within an upper limit of motor current and a lower limit of motor current over a period of time greater than a driver release activation time.

12. The impact driver according to claim 1, wherein the parameter is a motor current; and
the driver release condition comprises a first decrease of the motor current over a first time period, followed by a first increase in motor current over a second time period;
followed by a second decrease of the motor current over a third time period, followed by a second increase in motor current over a fourth time period;
followed by an increase in a motor current over each of a number of sequential sampling periods.

13. An impact driver control system, comprising:
an motor which provides a driving force to an impact mechanism;
an electronic controller which controls the state of a driver control system;
the controller monitoring a parameter of the impact driver to identify a driver release condition;
when the controller identifies the driver release condition, the driver control system activates a driver release which frees said impact mechanism from receiving said driving force;
wherein the driver release condition is satisfied by a first motor torque while driving a first fastener;
wherein the driver release condition is satisfied by a second motor torque while driving a second fastener; and
wherein the first motor torque is at least 3% different from the second motor torque.

14. The impact driver control system of claim 13, wherein the first motor torque is at least 10% different than the second motor torque.

15. The impact driver control system of claim 13, wherein the first motor torque is at least 20% different than the second motor torque.

16. The impact driver control system of claim 13, wherein the driver release condition is satisfied by a first driving time for the first fastener;
wherein the driver release condition is satisfied by a second driving time for the second fastener; and
wherein the first driving time is at least 20% different than the second driving time.

17. An impact driver, comprising:
a motor which provides a motor force that drives an impact mechanism;
a controller which is an electronic controller and which controls the state of a driver control system;
the controller monitoring a parameter of the impact driver;
the controller configured to activate the driver control system to free the output mechanism from the driving force when the parameter satisfies a driver release condition; and
wherein the driver release condition corresponds to a fastener being driven by the impact driver into a workpiece to a point where it is approximately flush with the workpiece.

18. The impact driver of claim 17, wherein the driver release condition varies such that a plurality of different fasteners can be driven into a workpiece or a plurality of different workpieces to an approximately flush condition.

19. The impact driver of claim 17, wherein the driver release condition varies such that a number of similar fasteners can be driven into a workpiece or a plurality of different workpieces to an approximately flush condition.

20. The impact driver according to claim 17, wherein the parameter is at least one of a current, an rpm of a motor and a torque.
